(19) United States
(12) Patent Application Publication
(10) Pub. No.: US 2025/0386227 A1
(43) Pub. Date: Dec. 18, 2025

(54) SIGNALING FOR RANDOM MEASUREMENT BEAM PATTERNS FOR BEAM MEASUREMENT PREDICTIONS

(71) Applicant: QUALCOMM Incorporated, San Diego, CA (US)

(72) Inventors: Qiaoyu LI, Beijing (CN); Hamed PEZESHKI, San Diego, CA (US); Tianyang BAI, Mountain View, CA (US); Mahmoud TAHERZADEH BOROUJENI, San Diego, CA (US); Tao LUO, San Diego, CA (US)

(21) Appl. No.: 18/876,558

(22) PCT Filed: Aug. 19, 2022
(86) PCT No.: PCT/CN2022/113489

§ 371 Date: Dec. 18, 2024

(51) Int. Cl. H04W 24/10; H04B 7/06; H04L 5/00; H04W 8/24; H04W 72/0446

(52) U.S. Cl. CPC H04W 24/10; H04B 7/0626; H04L 5/0057; H04W 8/24; H04W 72/0446

(57) ABSTRACT

Various aspects of the present disclosure generally relate to wireless communication. In some aspects, a user equipment (UE) may receive configuration information indicating one or more sets of channel measurement resources (CMRs) associated with a channel state information (CSI) report, indicating that the UE is to predict measurements for one or more CMRs from the one or more sets of CMRs, and indicating an association between subsets of CMRs, from the one or more sets of CMRs, and respective time domain measurement occasions. The UE may measure, at a time domain measurement occasion of the respective time domain measurement occasions, a subset of CMRs, from the subsets of CMRs, that is associated with the time domain measurement occasion. The UE may transmit the CSI report including predicted measurement values associated with the one or more CMRs. Numerous other aspects are described.

### FIELD OF THE DISCLOSURE

Aspects of the present disclosure generally relate to wireless communication and to techniques and apparatuses associated with signaling for random measurement beam patterns for beam measurement predictions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network node, configuration information indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The one or more processors may be configured to measure, at a time domain measurement occasion of the respective time domain measurement occasions, a subset of CMRs, from the subsets of CMRs, that is indicated as being associated with the time domain measurement occasion by the association. The one or more processors may be configured to transmit, to the network node, the CSI report, wherein the CSI report includes predicted measurement values associated with the one or more CMRs, and wherein the predicted measurement values are based at least in part on the measurements of the subset of CMRs.

Some aspects described herein relate to a network node for wireless communication. The network node may include a memory and one or more processors coupled to the memory. The one or more processors may be configured to transmit configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The one or more processors may be configured to receive the CSI report, wherein the CSI report includes predicted measurement values associated with the one or more CMRs, and wherein the predicted measurement values are based at least in part on measurements of a subset of CMRs from the subsets of CMRs.

Some aspects described herein relate to a method of wireless communication performed by a UE. The method may include receiving, from a network node, configuration information indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The method may include measuring, at a time domain measurement occasion of the respective time domain measurement occasions, a subset of CMRs, from the subsets of CMRs, that is indicated as being associated with the time domain measurement occasion by the association. The method may include transmitting, to the network node, the CSI report, wherein the CSI report includes predicted measurement values associated with the one or more CMRs, and wherein the predicted measurement values are based at least in part on the measurements of the subset of CMRs.

Some aspects described herein relate to a method of wireless communication performed by a network node. The method may include transmitting configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The method may include receiving the CSI report, wherein the CSI report includes predicted measurement values associated with the one or more CMRs, and wherein the predicted measurement values are based at least in part on measurements of a subset of CMRs from the subsets of CMRs.

Some aspects described herein relate to a non-transitory computer-readable medium that stores a set of instructions for wireless communication by a UE. The set of instructions, when executed by one or more processors of the UE, may cause the UE to receive, from a network node, configuration information indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The set of instructions, when executed by one or more processors of the UE, may cause the UE to measure, at a time domain measurement occasion of the respective time domain measurement occasions, a subset of CMRs, from the subsets of CMRs, that is indicated as being associated with the time domain measurement occasion by the association. The set of instructions, when executed by one or more processors of the UE, may cause the UE to transmit, to the network node, the CSI report, wherein the CSI report includes predicted measurement values associated with the one or more CMRs, and wherein the predicted measurement values are based at least in part on the measurements of the subset of CMRs.

Some aspects described herein relate to a non-transitory computer-readable medium that stores a set of instructions for wireless communication by a network node. The set of instructions, when executed by one or more processors of the network node, may cause the network node to transmit configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The set of instructions, when executed by one or more processors of the network node, may cause the network node to receive the CSI report, wherein the CSI report includes predicted measurement values associated with the one or more CMRs, and wherein the predicted measurement values are based at least in part on measurements of a subset of CMRs from the subsets of CMRs.

Some aspects described herein relate to an apparatus for wireless communication. The apparatus may include means for receiving, from a network node, configuration information indicating one or more sets of CMRs associated with a CSI report, wherein the configuration information indicates that the apparatus is to predict measurements for one or more CMRs from the one or more sets of CMRs, and wherein the configuration information indicates an association between subsets of CMRs, from the one or more sets of CMRs, and respective time domain measurement occasions. The apparatus may include means for measuring, at a time domain measurement occasion of the respective time domain measurement occasions, a subset of CMRs, from the subsets of CMRs, that is indicated as being associated with the time domain measurement occasion by the association. The apparatus may include means for transmitting, to the network node, the CSI report, wherein the CSI report includes predicted measurement values associated with the one or more CMRs, and wherein the predicted measurement values are based at least in part on the measurements of the subset of CMRs.

Some aspects described herein relate to an apparatus for wireless communication. The apparatus may include means for transmitting configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The apparatus may include means for receiving the CSI report, wherein the CSI report includes predicted measurement values associated with the one or more CMRs, and wherein the predicted measurement values are based at least in part on measurements of a subset of CMRs from the subsets of CMRs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture of a functional framework for radio access network (RAN) intelligence enabled by data collection, in accordance with the present disclosure.

FIG. 6 is a diagram illustrating an example of an artificial intelligence/machine learning (AI/ML) based beam management, in accordance with the present disclosure.

FIG. 7 is a diagram illustrating an example associated with signaling for random measurement beam patterns for beam measurement predictions, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

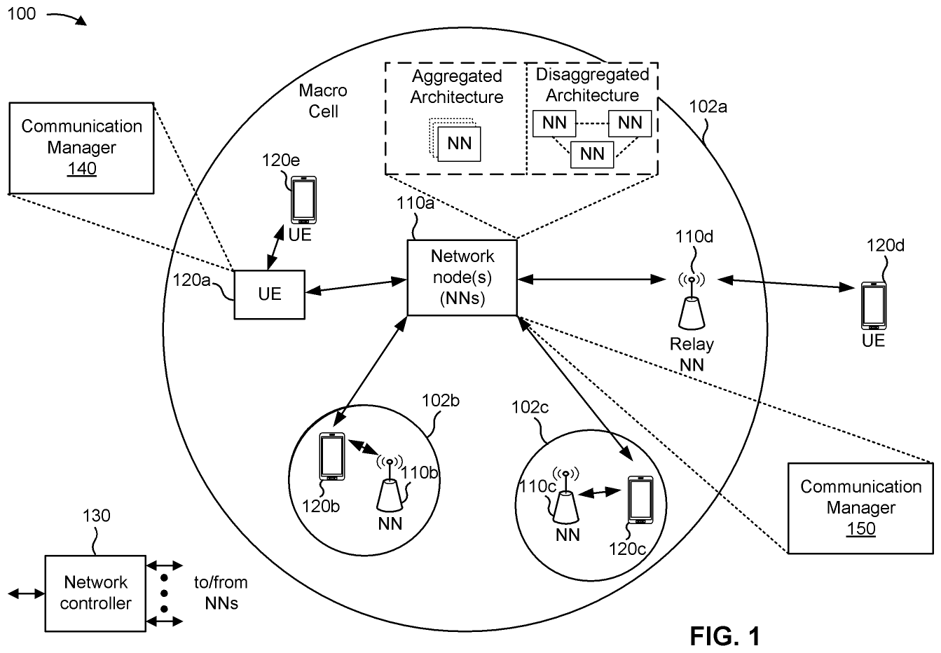

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Beamforming, which may also be referred to as spatial filtering, directional transmission, or directional reception, is a signal processing technique that may be used at a transmitting device or a receiving device (e.g., a network node 110, and/or a UE 120) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 110 or a UE 120 may use beam sweeping techniques as part of beamforming operations. For example, a network node 110 (e.g., a base station or an RU) may use multiple antennas or antenna arrays (e.g., antenna panels) to conduct beamforming operations for directional communications with a UE 120. Some signals (e.g., synchronization signals, reference signals, beam selection signals, or other control signals) may be transmitted by a network node 110 multiple times along different directions. For example, the network node 110 may transmit a signal according to different beamforming weight sets associated with different directions of transmission. Transmissions along different beam directions may be used to identify (e.g., by a transmitting device, such as a network node 110, or by a receiving device, such as a UE 120) a beam direction for later transmission or reception by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, configuration information indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; measure, at a time domain measurement occasion of the respective time domain measurement occasions, a subset of CMRs, from the subsets of CMRs, that is indicated as being associated with the time domain measurement occasion by the association; and transmit, to the network node, the CSI report, wherein the CSI report includes predicted measurement values associated with the one or more CMRs, and wherein the predicted measurement values are based at least in part on the measurements of the subset of CMRs. Additionally, or alternatively, the communication manager 140 may perform one or more other operations described herein.

In some aspects, the network node 110 may include a communication manager 150. As described in more detail elsewhere herein, the communication manager 150 may transmit configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; and receive the CSI report, wherein the CSI report includes predicted measurement values associated with the one or more CMRs, and wherein the predicted measurement values are based at least in part on measurements of a subset of CMRs from the subsets of CMRs. Additionally, or alternatively, the communication manager 150 may perform one or more other operations described herein.

As indicated above, FIG. 1 is provided as an example. Other examples may differ from what is described with regard to FIG. 1.

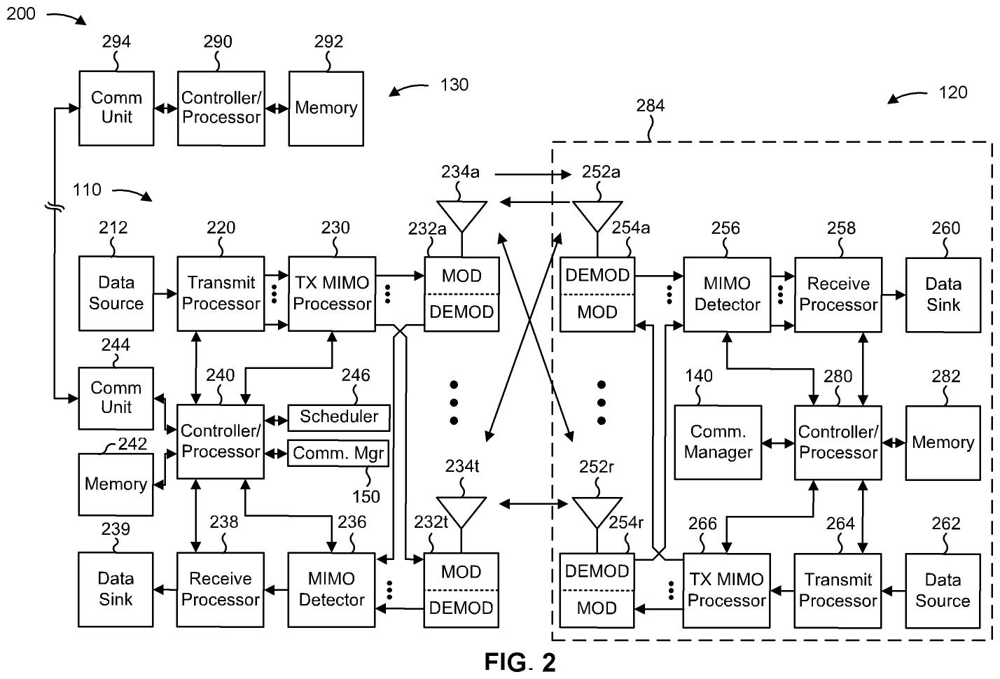

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

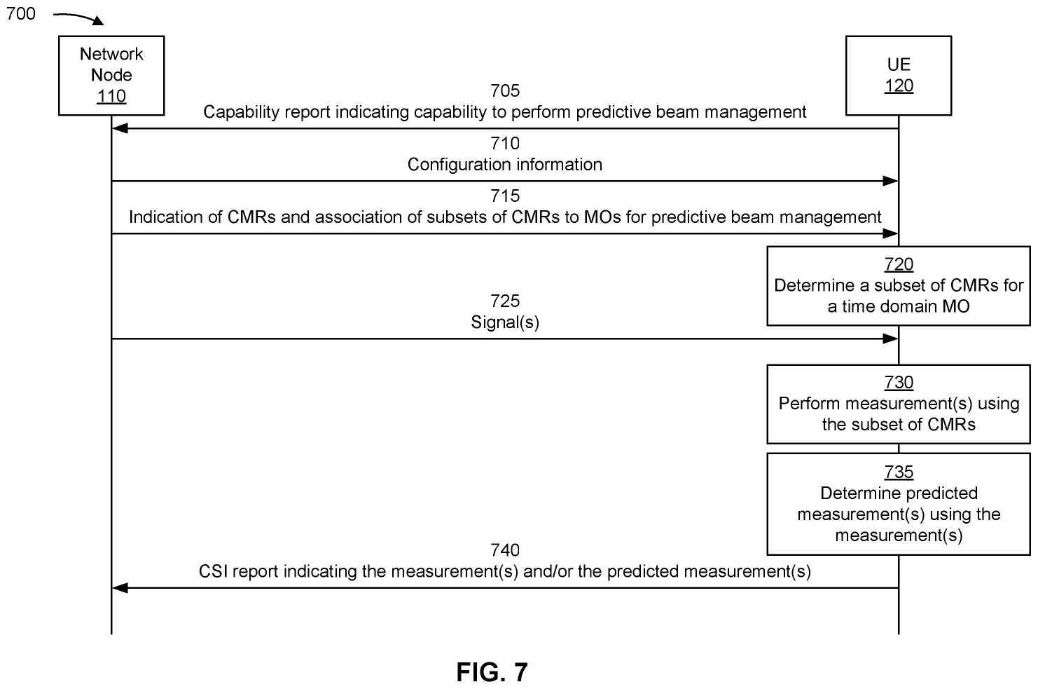

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

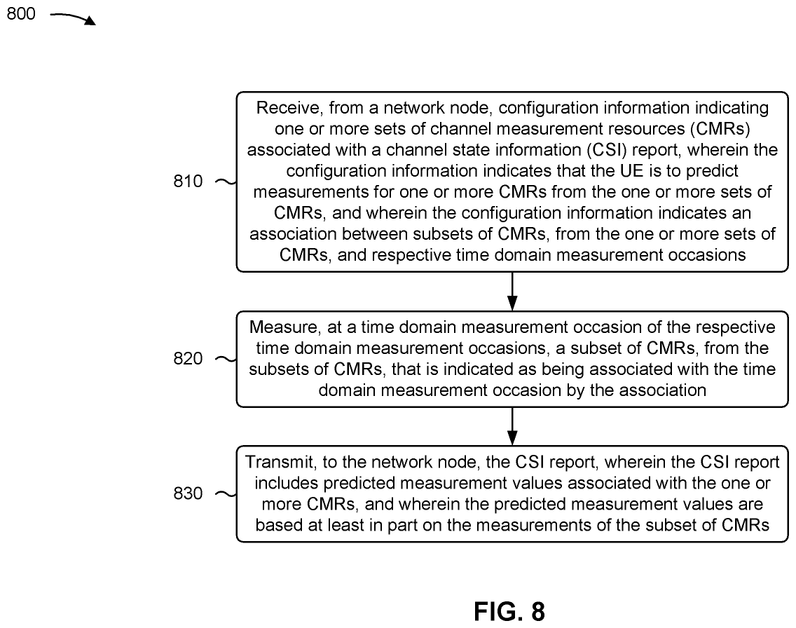

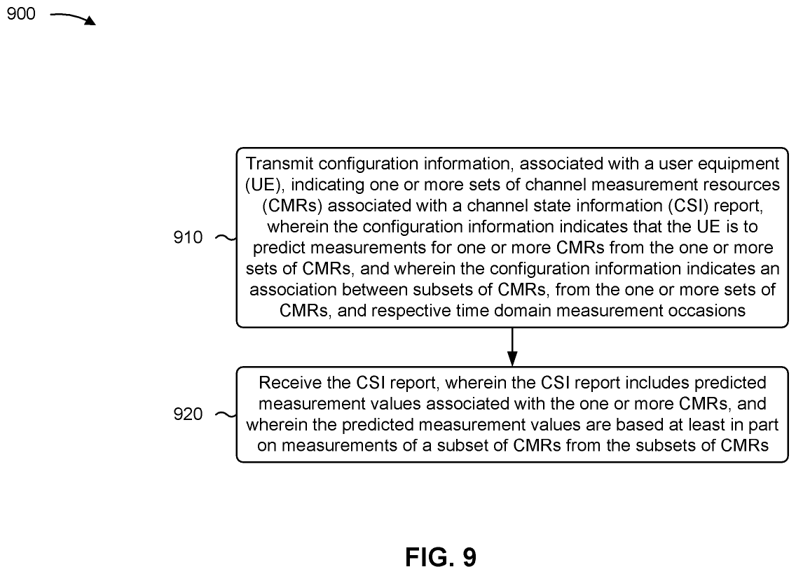

The controller/processor 240 of the network node 110, the controller/processor 280 of the UE 120, and/or any other component(s) of FIG. 2 may perform one or more techniques associated with signaling for random measurement beam patterns for beam measurement predictions, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from a network node, configuration information indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; means for measuring, at a time domain measurement occasion of the respective time domain measurement occasions, a subset of CMRs, from the subsets of CMRs, that is indicated as being associated with the time domain measurement occasion by the association; and/or means for transmitting, to the network node, the CSI report, wherein the CSI report includes predicted measurement values associated with the one or more CMRs, and wherein the predicted measurement values are based at least in part on the measurements of the subset of CMRs. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; and/or means for receiving the CSI report, wherein the CSI report includes predicted measurement values associated with the one or more CMRs, and wherein the predicted measurement values are based at least in part on measurements of a subset of CMRs from the subsets of CMRs. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

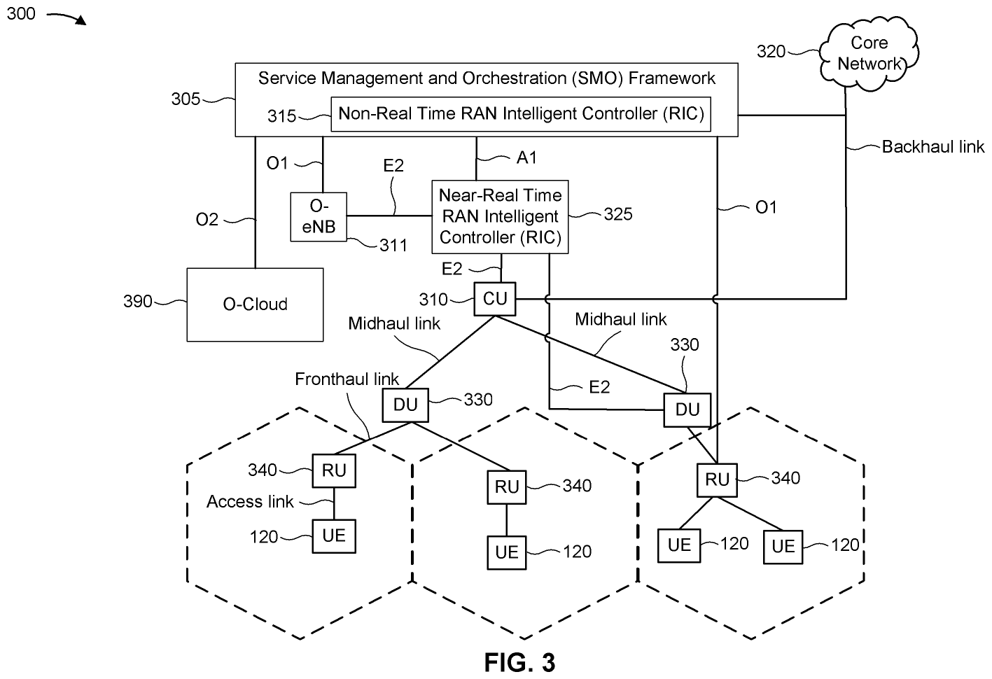

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325. In some examples, the near-RT RIC 325 may be a logical function that enables near-real-time control and optimization of O-RAN elements and resources via fine-grained data collection and actions over an E2 interface. The Near-RT RIC 325 may be co-located with the RAN or network entity to provide the real-time processing, such as online ML training or near real time ML inference. The non-RT RIC 315 may be a logical function that enables non-real-time control and optimization of RAN elements and resources, AI/ML workflow including model training and updates, and policy-based guidance of applications/features in near-RT RIC 325, as well as ML inference with less latency specification. The non-RT RIC 315 may be located further from the RAN or network node, such as on a cloud-based server or on an edge server.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

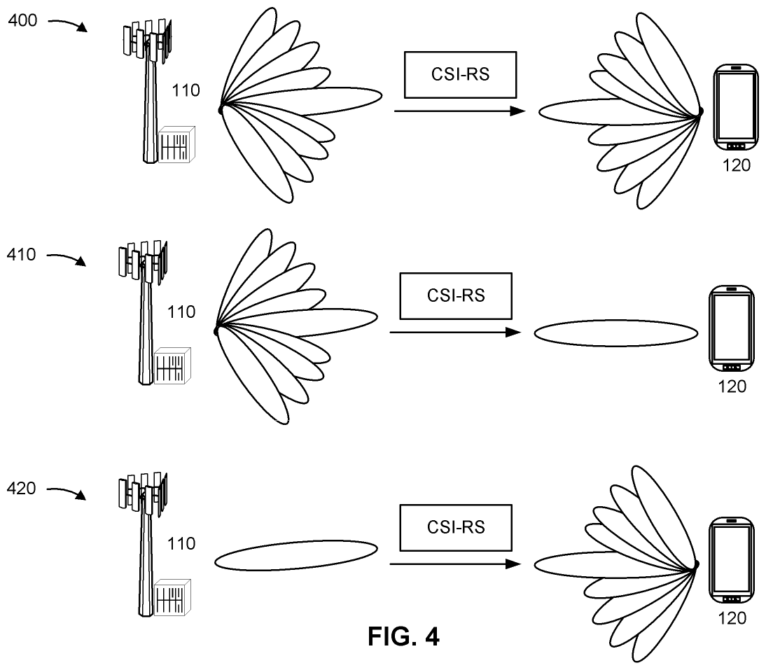

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using medium access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHz, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., a few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 4) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

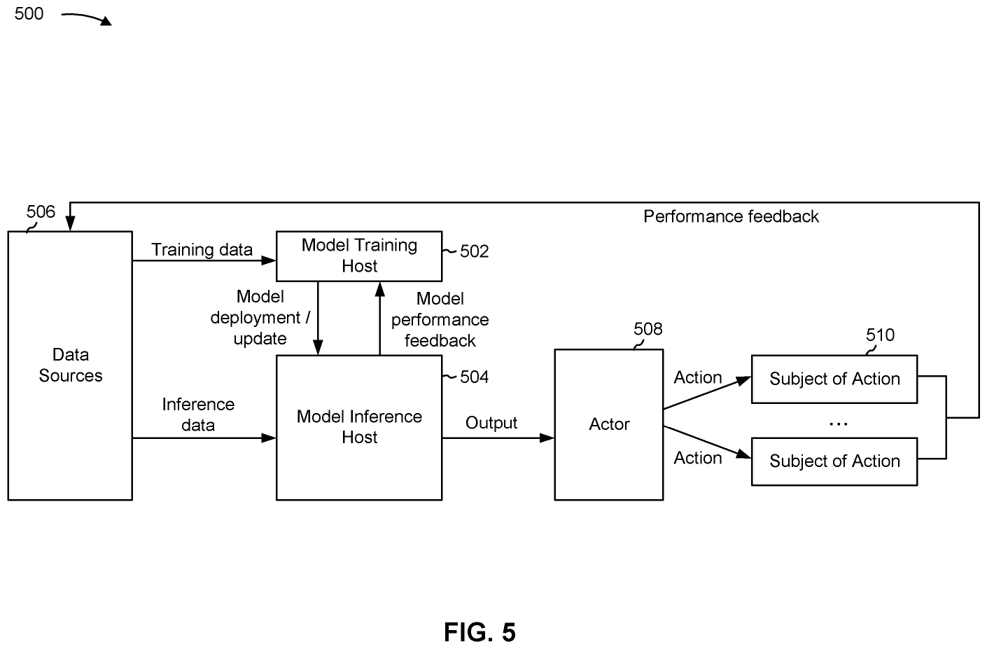

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the artificial intelligence (AI) functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU; whereas if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a Tx/Rx beam based on the output. If the actor 508 determines to act based on the output, the actor 508 may indicate the action to at least one subject of action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify its Tx/Rx beam based on the beam (re-)configuration, such as switching to a new Tx/Rx beam or applying different parameters for a Tx/Rx beam, among other examples. As another example, the actor 508 may be a UE and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

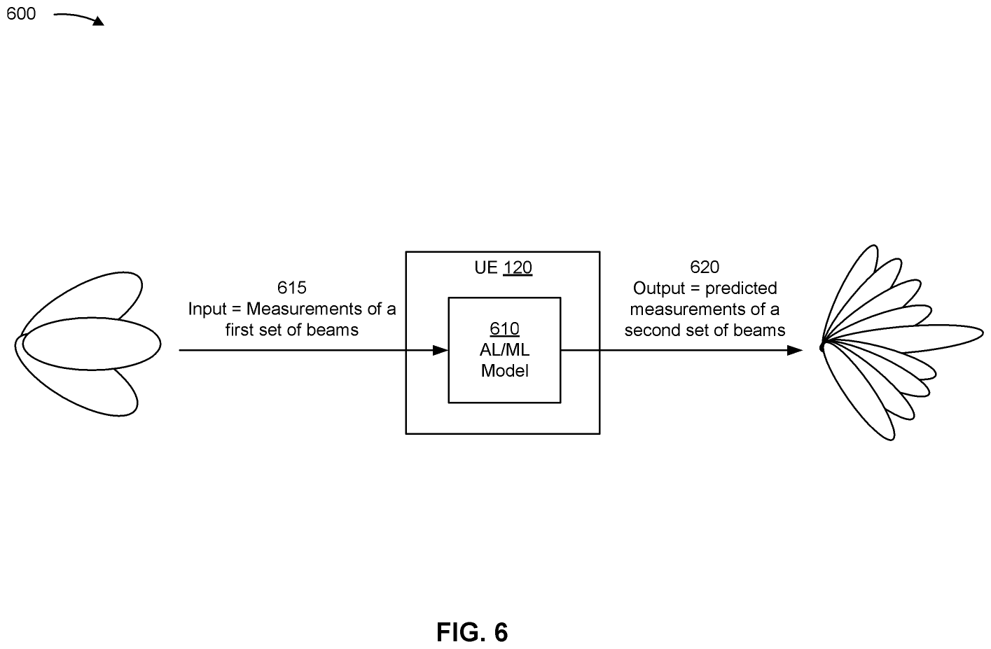

FIG. 6 is a diagram illustrating an example 600 of an AI/ML based beam management, in accordance with the present disclosure. As shown in FIG. 6, an AI/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. For example, a network node 110 may transmit one or more signals via respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook-based spatial domain selection or prediction. As another example, multiple measurement reports or values, collected at different points in time, may be input to the AI/ML model 610. This may enable the AI/ML model 610 to output codebook-based and/or non-codebook-based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedures, beam failure and/or beam blockage predictions, and/or radio link failure predictions, among other examples.

In some examples, beam measurement predictions may be performed by a UE (e.g., as depicted in FIG. 6) and/or by a network node 110 in a similar manner as described above. For example, a network node 110 may receive one or more measurements (e.g., performed by a UE 120) and may use an AI/ML model 610 to predict one or more measurements (e.g., of other beams) based at least in part on the one or more measurements performed by the UE 120. For example, predictions may be performed by a network node 110 because the network node 110 may have more processing resources and/or a greater processing capability than a UE 120. Additionally, the network node 110 may have access to historical measurement reports and/or measurement reports from other UEs that may be used as inputs to the AI/ML model 610 (e.g., which may improve an accuracy of an output of the AI/ML model 610). Predictions may be performed by the UE 120 because the UE 120 may have access to filtered measurements of all beams (e.g., not all measurements may be reported to the network node 110). Additionally, the UE 120 may have information related to the receive beam(s) used to derive or perform the measurements (e.g., which may be a useful input for the AI/ML model 610). As another example, the measurement information at the UE 120 may be “raw” or non-quantized, thereby providing more information that can be input into the AI/ML model 610. Further, the UE 120 may have knowledge of an orientation or a rotational position of the UE 120.

In some examples, the first set of beams (e.g., that are measured) may be referred to as Set B beams and the second set of beams (e.g., that are associated with predicted measurements) may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

In some examples, beams included in the first set of beams (e.g., the set B beams) may be fixed over time and/or may follow a set or predictable pattern. For example, at various time domain measurement occasions, beams included in the first set of beams (e.g., the set B beams to be measured by the UE 120 to facilitate a prediction of measurements of the set A beams) may be fixed (e.g., the same) or may follow a set pattern. For example, the set A beams may include 16 beams and the set B beams may be a subset of the set A beams. At each time domain measurement occasion, the set B beams may be the same subset of the set A beams. In other examples, the set B beams may change at different time domain measurement occasions, but may follow a set or predictable pattern, such as a round-robin pattern.

In some cases, using a fixed set of set B beams over time may degrade a performance of predictions made by the AI/ML model 610 (e.g., that is deployed at a UE 120 or a network node 110). For example, one or more beams included in the set B beams may be associated with a beam blockage, interference, or another intervening factor that degrades performances of signals communicated via the one or more beams. For example, higher frequency bands may encounter higher attenuation and diffraction losses, where a blockage of an LOS path may degrade a wireless link quality. Therefore, using a fixed set of Set B beams over time may result in inaccurate or degraded performance of predicted measurements for beams included in the set A. However, using non-fixed (or random) Set B beams over time may introduce additional challenges because the wireless communication device (e.g., a UE 120 and/or a network node 110) may not know which beams (or channel measurement resources) to measure at a given measurement occasion. Further, in examples where the UE 120 is performing the predictions, the UE 120 and a network node 110 may not be synchronized as to which beams are to be associated with a transmission (and measurement) and which beams are to be measured. As a result, the UE 120 may attempt to measure a beam that is not associated with a transmission, resulting in a misleading measurement value (e.g., because the measurement value may be low because there is no transmission associated with the beam, and not because of poor channel conditions or another condition) being provided as an input to the AI/ML model 610, thereby degrading an accuracy of one or more predicted measurement values.

Some techniques and apparatuses described herein enable signaling for random measurement beam patterns for beam measurement predictions. For example, the UE 120 may receive configuration information indicating one or more sets of CMRs associated with a CSI report. In some aspects, the configuration information may indicate that the UE 120 is to predict measurements for one or more CMRs from the one or more sets of CMRs. In some aspects, an association between subsets of CMRs, from the one or more sets of CMRs, and respective time domain measurement occasions may be defined (e.g., by the configuration information or by another communication from a network node). In some aspects, the subsets of CMRs, from the one or more sets of CMRs, may be randomly selected. The UE 120 may measure, at a time domain measurement occasion of the respective time domain measurement occasions, a subset of CMRs, from the subsets of CMRs, that is indicated as being associated with the time domain measurement occasion by the association. The UE 120 may transmit the CSI report, where the CSI report includes predicted measurement values associated with the one or more CMRs, and wherein the predicted measurement values are based at least in part on the measurements of the subset of CMRs.

As a result, the UE 120 may be enabled to use a random pattern of CMRs (e.g., a random pattern of set B beams) to measure to facilitate beam measurement predictions. For example, the signaling described herein may ensure that the UE 120 and one or more network nodes (e.g., a network node that transmits signals to be measured by the UE 120 and/or a network node that receives the CSI report) are synchronized as to which beams (e.g., which CMRs) are to be measured by the UE 120 at a given time domain measurement occasion. Enabling the use of a random pattern of CMRs (e.g., a random pattern of set B beams) to be measured by the UE 120 to facilitate beam measurement predictions may improve a performance and/or accuracy of the beam measurement predictions (e.g., because the predictions may not be based on actual beam measurements of a beam that is associated with a blockage, interference, or another condition affecting performances of signals communicated via the beam).

As indicated above, FIG. 6 is provided as an example. Other examples may differ from what is described with regard to FIG. 6.

FIG. 7 is a diagram illustrating an example 700 associated with signaling for random measurement beam patterns for beam measurement predictions, in accordance with the present disclosure. As shown in FIG. 7, a network node 110 (e.g., a base station, a CU, a DU, and/or an RU) may communicate with a UE 120. In some aspects, the network node 110 and the UE 120 may be part of a wireless network (e.g., the wireless network 100). The UE 120 and the network node 110 may have established a wireless connection prior to operations shown in FIG. 7.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 7, and by reference number 705, the UE 120 may transmit, and the network node 110 may receive, a capability report. The capability report may indicate that the UE 120 supports performing predictive beam management, as described herein. For example, the capability report may indicate that the UE 120 supports performing one or more operations as described in connection with FIGS. 5 and 6. In some aspects, the capability report may indicate that the UE 120 supports identifying beam information for performing predictive beam management using random sets (or subsets) of CMRs over time, as described in more detail elsewhere herein. In some aspects, the UE 120 may be configured to perform one or more operations described herein based at least in part on the capability report indicating that the UE 120 supports performing predictive beam management.

As shown by reference number 710, the network node 110 may transmit, and the UE 120 may receive, configuration information. In some aspects, the UE 120 may receive the configuration information via one or more of system information signaling, RRC signaling, one or more MAC-CEs, and/or DCI, among other examples. In some aspects, the configuration information may include an indication of one or more configuration parameters (e.g., already stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to perform predictive beam management. For example, the configuration information may indicate that the UE 120 is to use an AI/ML model and/or a model inference host deployed at, or associated with, the UE 120 to predict measurement values (e.g., L1 RSRP values, L1 signal-to-interference-plus-noise ratio (SINR) values, CQIs, rank indicators (RIs), precoding matrix indicators (PMIs), layer indications (LIs), and/or other values or parameters) associated with one or more beams. For example, the configuration information may indicate that the UE 120 is to predict measurement values associated with transmit beam(s) of the network node 110 (e.g., of an RU) using measurement value(s) (e.g., obtained by the UE 120) of other transmit beam(s) of the network node 110.

In some aspects, the configuration information may indicate one or more sets of resources. In some aspects, the one or more sets of resources may include downlink reference signal resources, such as SSB resources or CSI-RS resources, among other examples. In some aspects, the one or more sets of resources may be one or more sets of channel measurement resources (CMRs) for CSI reporting (e.g., may be indicated via a resourcesForChannelMeasurement information element). In some aspects, a given resource (e.g., a given CMR) may be associated with a beam. For example, the network node 110 may associate a given resource with a given beam. In the case where the resource is used for transmission by the network node 110, the network node 110 may transmit using the resource and the beam. In some aspects, the configuration information may indicate that the UE 120 is to predict measurements for one or more CMRs from the one or more sets of CMRs.

In some aspects, the configuration information may include a CSI configuration. For example, the configuration information may include a CSI report setting and/or a CSI resource setting, among other examples. As another example, the configuration information may include a CSI-ReportConfig configuration and/or a CSI-ResourceConfig configuration, among other examples. In other words, the configuration information may configure the UE 120 to transmit a CSI report including information (e.g., measurements) associated with the one or more sets of resources. As described above, the one or more sets of resources may be CMRs for the CSI report.

In some aspects, the configuration information may indicate a report quantity configuration for the CSI report. For example, the UE 120 may be configured with a (SI-ReportConfig with the higher layer parameter reportQuantity set to either none, cri-RI-PMI-CQI, cri-RI-il, cri-RI-il-CQI, cri-RI-CQI, cri-RSRP, ssb-Index-RSRP, or cri-RI-LI-PMI-CQI, among other examples (for example, as defined, or otherwise fixed, by the 3GPP). The report quantity may indicate or configure what is to be included in the CSI report, what the UE 120 is to expect to be configured with for the CSI report, among other examples. In other words, the report quantity may indicate what kind of quantity (e.g., SSB RSRP, CQI, PMI, and/or RI) should be measured and reported by the UE 120. For example, a wireless communication standard, such as the 3GPP, may define expectations and/or configurations for the CSI report for different values of the report quantity. For example, the UE 120 may receive a configuration (e.g., a CSI report setting, a CSI resource setting, a CSI-ReportConfig, and/or a CSI-ResourceConfig) for the CSI report. The configuration may indicate that the one or more sets of resources are CMRs associated with the CSI report.

In some aspects, the configuration information may indicate an association between subsets of CMRs, from the one or more sets of CMRs, and respective time domain measurement occasions for CSI reporting. For example, the CSI configuration may configure the UE 120 to perform measurements over time. A time at which the UE 120 is to perform a measurement for the CSI reporting may be referred to as a “time domain measurement occasion.” For example, a time domain measurement occasion may be associated with time domain resources (e.g., time domain radio resources) of a signal that is to be measured by the UE 120. The CSI configuration may configure the UE 120 to perform measurements at various time domain measurement occasions over time. In some aspects, the configuration information (e.g., the CSI configuration or another configuration) may indicate an association between subsets of CMRs (that are randomly generated from the one or more sets of CMRs, as described in more detail elsewhere herein) at respective measurement occasions. In other words, the configuration information may indicate which subset of CMRs, from the subsets of CMRs, is to be measured by the UE 120 at a given time domain measurement occasion.

In some aspects, the configuration information may indicate a manner in which the subsets of CMRs are to be generated from the one or more sets of CMRs. For example, a set of CMRs (e.g., a CMR set) may include multiple CMRs. In some aspects, the configuration information may indicate a formulation or technique to be used to generate the subsets of CMRs from the multiple CMRs. For example, the configuration information may indicate one or more random seed values (or randomization seeds) to be used to generate or determine the subsets of CMRs from the multiple CMRs. A random seed value may be a base value or a vector that may be used to initialize a pseudorandom number generator. The pseudorandom number generator may be deployed at the UE 120. The pseudorandom number generator may output an indication (e.g., an index value or an identifier) of CMRs to be included in a given subset of CMRs. As another example, a pseudorandom number generator may output an indication (e.g., an index value or an identifier) of a source reference signal (e.g., a quasi co-location (QCL) source reference signal or a transmission configuration indicator (TCI) state source reference signal) associated with a CMR to be included in a given subset of CMRs.

In some aspects, the configuration information may indicate a CMR pattern. For example, the subsets of CMRs, from the one or more sets of CMRs, may be based at least in part on the CMR pattern (e.g., where the CMR pattern defines CMRs that are included in the subsets of CMRs). In some aspects, the CMR pattern may be a random pattern. For example, the CMR pattern may be a random pattern defined by one or more random seed values. For example, different network nodes may be associated with different random or semi-random patterns for selecting set B beams. For example, different network nodes may determine or identify different random or semi-random patterns for selecting set B beams during training or testing of an AI/ML model. Therefore, the pattern (e.g., the CMR pattern) to be used to select CMRs to be included in various subsets of CMRs may be configured and/or indicated (e.g., dynamically) for the UE 120, as described herein.

In some aspects, the configuration information may indicate an AI/ML model to be used by the UE 120 for predictive beam management. For example, the UE 120 may download the AI/ML model from the network (e.g., from the network node 110). In some aspects, the AI/ML model may be trained by the network node 110 and provided to the UE 120. In other aspects, the UE 120 may train the AI/ML model. In some aspects, the AI/ML model may be pre-configured (e.g., in an original equipment manufacturer (OEM) configuration) on the UE 120. In some aspects, the configuration information may indicate one or more inputs to be provided to the AI/ML model, such as one or more measurement values, a CMR pattern, and/or QCL information of CMRs that are measured by the UE 120, among other aspects. In some aspects, the configuration information may indicate one or more outputs to be provided by the AI/ML model, such as predicted L1 RSRP values, predicted L1 SINR values, predicted CQIs, predicted RIs, predicted PMIs, predicted LIs, and/or other predicted values or parameters associated with the one or more sets of CMRs.

The UE 120 may configure itself based at least in part on the configuration information. In some aspects, the UE 120 may be configured to perform one or more operations described herein based at least in part on the configuration information.

In some aspects, the network node 110 may transmit signals using all CMRs included in the one or more sets of CMRs. For example, the CMRs included in the one or more sets of CMRs may define set A beams associated with a predictive beam management procedure (e.g., where a subset of CMRs for a given measurement occasion defines the set B beams for that given measurement occasion). In some aspects, the network node 110 may transmit signals using all beams (e.g., all CMRs) in the set A beams. In other examples, the network node 110 may not transmit signals using all CMRs included in the one or more sets of CMRs. For example, the network node 110 may only transmit signals via set B beams for a given measurement occasion. In other words, the network node 110 may only transmit signals via a subset of CMRs for a given measurement occasion (e.g., and may not transmit signals using other CMRs included in the one or more sets of CMRs). For example, the network node 110 may transmit, at a time domain measurement occasion, signals using CMRs that are to be measured by the UE 120 at the time domain measurement occasion. This may conserve network resources that would have otherwise been used to transmit signals using all CMRs included in the one or more sets of CMRs.

As shown by reference number 715, the network node 110 may transmit, and the UE 120 may receive, an indication of subsets of CMRs (e.g., from the one or more sets of CMRs) and an indication of an association between the subsets of CMRs and time domain measurement occasions (MOs) for predictive beam management. In some aspects, the indications may be included in the configuration information. In some other aspects, the indications may be included in a different communication, such as a MAC-CE communication or a DCI communication. In some aspects, the configuration information may configure multiple options for subsets of CMRs and/or associations between CMRs and time domain measurement occasions (e.g., for aperiodic CSI reports and/or semi-persistent CSI reports). In such examples, the network node 110 may transmit, and the UE 120 may receive, an indication of an option for subsets of CMRs and/or associations between CMRs and time domain measurement occasions (e.g., from the multiple configured options).

In some aspects, the indication of subsets of CMRs may include an indication of a CMR pattern. For example, a CMR pattern may indicate which CMRs, from a set of CMRs, are to be measured by the UE 120 at a given time domain measurement occasion. In other words, the CMR pattern may indicate one or more subsets of CMRs from a set of CMRs (e.g., a configured set of CMRs). Additionally, the CMR pattern may indicate an association between the one or more subsets of CMRs and time domain measurement occasions (e.g., indicating which subset of CMRs, from the subsets of CMRs, is to be measured by the UE 120 at a given time domain measurement occasion). In some aspects, the one or more subsets of CMRs may include randomly selected CMRs from the set of CMRs. For example, as described elsewhere herein, the UE 120 may randomly select CMRs from the set of CMRs to determine the one or more subsets of CMRs. In some aspects, measurements of one or more subsets of CMRs and the CMR pattern may be provided as inputs to a prediction model (e.g., an AI/ML model used for beam measurement predictions).

In some aspects, the CMR pattern may be a random pattern that is defined by one or more random seed values. For example, the UE 120 may receive, and the network node 110 may transmit, an indication of the one or more random seed values (e.g., in the configuration information or in another communication). For example, a connection between CMR subset selection and an associated time occasion (e.g., a time domain measurement occasion) may be based at least in part on a random pattern defined by randomization seeds. The random pattern may be based at least in part on using a formulation that includes an input that includes the one or more random seed values (e.g., that may be configured and/or indicated by the network node 110) and an output that includes multiple sets of subset selection indices, where each set of subset selection indices includes multiple CMR identifiers from the CMRs associated with the CSI report. In some aspects, the formulation may be defined, or otherwise fixed, by a wireless communication standard, such as the 3GPP. Additionally, or alternatively, the formulation may be indicated to the UE 120 by the network node 110. In some aspects, the formulation may be based at least in part on a slot, subframe, and/or frame identifier associated with a given measurement occasion. In other words, an input to the formulation may include the slot, subframe, and/or frame identifier associated with a given measurement occasion. For example, the CMR pattern may be based at least in part on at least one of a slot, subframe, and/or frame identifier associated with the CSI report and/or a measurement occasion.

For example, the UE 120 may receive, and the network node 110 may transmit, an indication of the one or more random seed values. The UE 120 may determine one or more subsets of CMRs based on the one or more sets of CMRs and the one or more random seed values. For example, the UE 120 may obtain one or more subsets of CMRs using the one or more random seed values and the one or more sets of CMRs. The UE 120 may determine or identify an association between the subsets of CMRs and the respective time domain measurement occasions associated with the CSI configuration.

For example, the association between the subsets of CMRs, from the one or more sets of CMRs, and the respective time domain measurement occasions may be based at least in part on the CMR pattern and may be defined by a wireless communication standard, such as the 3GPP (e.g., a mapping or association between subset identifiers and measurement occasion identifiers may be defined). Additionally, or alternatively, the association between the subsets of CMRs, from the one or more sets of CMRs, and the respective time domain measurement occasions may be based at least in part on the CMR pattern and may be included in the configuration information (e.g., may be configured or indicated by the network node 110). For example, the network node 110 may transmit, and the UE 120 may receive, an indication of a mapping or association between the subset identifiers and measurement occasion identifiers. For example, the network node 110 may indicate that a subset A is to be used by the UE 120 in a measurement occasion 1, a subset B is to be used by the UE 120 in a measurement occasion 2, the subset B is to be used by the UE 120 in a measurement occasion 3, a subset C is to be used by the UE 120 in a measurement occasion 4, and so on. For example, the network node 110 may indicate that the same subset is to be used by the UE 120 (e.g., is to be measured by the UE 120) during multiple time domain measurement occasions. In other words, each subset of CMRs (e.g., selected by the UE 120 using random seed(s)) may be associated with a certain measurement occasion, where the association may be determined based on a definition promulgated by a wireless communication standard and/or indicated by the network node 110.

In some aspects, the UE 120 may receive, and the network node 110 may transmit, an indication of the CMR pattern. For example, the indication of the CMR pattern may indicate CMRs that are included in each of the subsets of CMRs. In other words, rather than the UE 120 determining the subsets of CMRs (e.g., using the one or more random seed values), the UE 120 may receive an indication of the subsets of CMRs (e.g., from the network node 110). For example, the subsets of CMRs may be explicitly indicated by the network node 110 (e.g., in the configuration information, in an RRC message, a MAC-CE message, and/or a DCI message). In such examples, the association between the subsets of CMRs, from the one or more sets of CMRs, and the respective time domain measurement occasions may be defined by a wireless communication standard, such as the 3GPP (e.g., a mapping or association between subset identifiers and measurement occasion identifiers may be defined). Additionally, or alternatively, the association between the subsets of CMRs, from the one or more sets of CMRs, and the respective time domain measurement occasions may be included in the configuration information (e.g., may be configured or indicated by the network node 110). For example, the network node 110 may transmit, and the UE 120 may receive, an indication of a mapping or association between the subset identifiers and measurement occasion identifiers.

In some aspects, only a single subset of CMRs may be used by the UE 120. For example, the indication of the CMR pattern may indicate that the subsets of CMRs are a single subset of CMRs. In such examples, the UE 120 may use the single subset of CMRs to predict beam measurement values and/or beam parameters of all CMRs and for each time domain measurement occasion.

In some aspects, the CMR pattern may be indicated via a CSI report setting associated with the CSI report. For example, for periodic CSI reports, a single option of subset selection patterns (e.g., a single CMR pattern) may be RRC configured by the CSI report setting associated with the CSI report. In other examples, a CSI report setting associated with the CSI report may indicate multiple CMR patterns (e.g., for semi-persistent and/or aperiodic CSI reports). In such examples, the CMR pattern may be indicated via a MAC-CE communication activating the CSI report (e.g., for semi-persistent CSI reports) or a downlink control information communication triggering the CSI report (e.g., for aperiodic CSI reports). For example, there may be multiple options of subset selection patterns (indicated to the UE 120 as described above), that are RRC configured by the CSI report setting associated with the CSI report. A MAC-CE activating the CSI report may indicate one of the options. As another example, a CSI triggering state configuration associated with the CSI report may be associated with one of the options. The UE 120 may identify an option based at least in part on the CSI triggering state being indicated by DCI.

As another example, the UE 120 may receive, and the network node 110 may transmit, QCL information associated with the one or more sets of CMRs, where the subsets of CMRs are defined via the QCL information and the association. The QCL information may include QCL type D (e.g., as defined, or otherwise fixed, by the 3GPP). For example, QCL type D information may include a spatial receive parameter (e.g., which may enable the UE 120 to identify spatial information associated with a receive beam or receive a spatial direction to be used to receive a signal associated with a given CMR). In some aspects, the QCL information may be included in the configuration information. Additionally, or alternatively, the QCL information may be indicated via MAC-CE signaling or DCI signaling. In some aspects, the UE 120 may provide measurements of one or more subsets of CMRs and the QCL information as inputs to the prediction model.

For example, the UE 120 may be requested to predict one or more beam measurements or beam parameters for a set of beams (e.g., a set of beams that are not used for transmission by the network node 110) in a CSI report. The prediction may be based at least in part on the UE 120 measuring CMRs associated with the CSI report, where a connection between QCL information (e.g., QCL Type D information) of the CMRs and respective measurement occasions may be configured for (e.g., via RRC signaling), or indicated to (e.g., via MAC-CE signaling and/or DCI signaling), the UE 120.

In some aspects, the UE 120 may determine the subsets of CMRs based at least in part on the QCL information and one or more random seed values (e.g., one or more random seed values that are configured and/or indicated in a similar manner as described elsewhere herein). For example, each subset of CMRs, from the one or more sets of CMRs, may include one or more QCL source resource identifiers indicated by the QCL information. The UE 120 may use the one or more QCL source resource identifiers to determine spatial information and/or a TCI state to be used to receive and/or measure a CMR. For example, the subsets of CMRs may be based at least in part on randomly selected QCL source resource identifiers indicated by the QCL information. In some aspects, the association (e.g., between the subsets of CMRs and the respective time domain measurement occasions) may be defined by a wireless communication standard or included in the configuration information, in a similar manner as described elsewhere herein. In some aspects, the randomly selected QCL source resource identifiers may be based at least in part on at least one of a slot, subframe, or frame identifier associated with the CSI report and/or with a given measurement occasion, in a similar manner as described elsewhere herein.

In some aspects, candidate QCL Type D source resources may be configured via a CSI configuration (e.g., a CSI report setting). For example, the QCL information may be included in a CSI report setting associated with the CSI report. The CSI report setting (or another CSI configuration) may indicate candidate QCL Type D source resources. For example, the CSI report setting may configure 64 QCL Type D source resources (e.g., TCI states, SSBs, and/or CSI-RSs) as the candidate QCL Type D source resources. The QCL Type D source resources may be provided as inputs to the random seed value formulation. The random seed value formulation may output N (e.g., 8 or another quantity) QCL Type D source resources (e.g., from the candidate QCL Type D source resources) that are associated with a given subset of CMRs. The random seed value formulation may be associated with an output of one or more sets of N QCL Type D source resources (e.g., where each set of N QCL Type D source resources defines a given subset of CMRs).

In some aspects, the UE 120 may receive, and the network node 110 may transmit, an indication of QCL information associated with the subsets of CMRs. For example, the indication of the QCL information may indicate QCL information for CMRs that are included in each of the subsets of CMRs. In other words, rather than the UE 120 determining the subsets of CMRs (e.g., using the one or more random seed values of candidate QCL source references), the UE 120 may receive an indication of the QCL information for the subsets of CMRs (e.g., from the network node 110). For example, the QCL information for the subsets of CMRs may be explicitly indicated by the network node 110 (e.g., in the configuration information, in an RRC message, a MAC-CE message, and/or a DCI message). In such examples, the association between the subsets of CMRs, from the one or more sets of CMRs, and the respective time domain measurement occasions may be defined by a wireless communication standard, such as the 3GPP (e.g., a mapping or association between subset identifiers and measurement occasion identifiers may be defined). Additionally, or alternatively, the association between the subsets of CMRs, from the one or more sets of CMRs, and the respective time domain measurement occasions may be included in the configuration information (e.g., may be configured or indicated by the network node 110). For example, the network node 110 may transmit, and the UE 120 may receive, an indication of a mapping or association between the subset identifiers and measurement occasion identifiers. Additionally, candidate QCL Type D source resources may be configured via a CSI configuration (e.g., a CSI report setting, in a similar manner as described above) and the UE 120 may receive an explicit indication of QCL Type D source resources, from the candidate QCL Type D source resources, that are associated with each subset of CMRs.

In some aspects, the QCL information may be indicated via a CSI report setting associated with the CSI report. For example, for periodic CSI reports, a single option of QCL information (e.g., a single CMR pattern) may be RRC configured by the CSI report setting associated with the CSI report. In other examples, a CSI report setting associated with the CSI report may indicate multiple options of QCL information (e.g., for semi-persistent and/or aperiodic CSI reports). In such examples, the QCL information may be indicated via a MAC-CE communication activating the CSI report (e.g., for semi-persistent CSI reports) or a downlink control information communication triggering the CSI report (e.g., for aperiodic CSI reports). For example, there may be multiple options of subset selection patterns of QCL information (indicated to the UE 120 as described above) that are RRC configured by the CSI report setting associated with the CSI report. A MAC-CE activating the CSI report may indicate one of the options. As another example, a CSI triggering state configuration associated with the CSI report may be associated with one of the options. The UE 120 may identify an option based at least in part on the CSI triggering state being indicated by DCI.

In some aspects, the one or more sets of CMRs include multiple sets of CMRs (e.g., multiple CMR sets) associated with the same CSI report. The multiple sets of CMRs may each be associated with the same (or similar) time domain periodicity, but different time domain offset values. The time domain offset value may an amount of time from a reference time that a first time domain occasion associated with a set of CMRs occurs. As a result, the multiple sets of CMRs may occur at, or be associated with, different time domain measurement occasions. For example, the multiple sets of CMRs may be distributed evenly over time (e.g., because of the same, or similar, time domain periodicity) at different time domain measurement occasions (e.g., because of the different time domain offset values).

For example, the UE 120 may be requested (e.g., by the network node 110) to predict beam measurement values and/or parameters for a set of non-transmitted beams associated with a CSI report, and further to report one or more of the predicted beam measurement values and/or parameters in the CSI report. The prediction may be based at least in part on the UE 120 measuring the multiple CMR sets associated with the CSI report. The prediction may be based at least in part on a measurement of a given set of CMRs, from the multiple sets of CMRs, and on the multiple sets of CMRs. For example, the predicted measurement values associated with the one or more CMRs may be based at least in part on an output of a prediction model, and the measurements of a subset of CMRs (e.g., a set of CMRs from the multiple sets of CMRs) and the multiple sets of CMRs may be provided as inputs to the prediction model.

In some aspects, the UE 120 may expect that the multiple CMR sets are associated with the same (e.g., identical) time domain periodicities and different time domain offsets. Additionally, or alternatively, the UE 120 may expect that the multiple CMR sets are associated with an at least partially different set of QCL source resources (e.g., QCL Type D source resources).

In some aspects, the multiple sets of CMRs may be selected and/or generated by the UE 120 using a random pattern (e.g., by randomly selecting sets of CMRs from candidate sets of CMRs). For example, the multiple sets of CMRs may include randomly selected CMR sets. The randomly selected CMR sets may be based at least in part on one or more random seed values and candidate CMR sets. For example, the random pattern can be based on using a formulation including an input that includes one or more random seed values (e.g., that may be configured and/or indicated to the UE 120 by the network node 110, in a similar manner as described elsewhere herein) and an output that includes the multiple sets of CMRs. For example, using the one or more random seed values, the UE 120 may randomly select the multiple sets of CMRs from candidate CMR sets.

The candidate CMR sets may be configured as part of the CSI configuration. The candidate CMR sets may be indicated via RRC signaling. For example, the candidate CMR sets may be indicated via a CSI report setting associated with the CSI report. In other words, the candidate CMR sets may configured as (e.g., conventional) CMR sets and the signaling and/or selection (e.g., using random patterns and/or random seed value(s)) may be used to randomly select the multiple sets of CMRs from the candidate CMR sets.

In some aspects, the multiple sets of CMRs may be explicitly indicated and/or configured. For example, the UE 120 may receive, and the network node 110 may transmit, an indication of the multiple sets of CMRs. For example, the network node 110 may configure (e.g., in an RRC communication or the CSI configuration) the multiple sets of CMRs. As another example, the UE 120 may receive, and the network node 110 may transmit, a signal (e.g., a MAC-CE signal and/or a DCI signal) indicating (e.g., explicitly) the multiple sets of CMRs.

In some aspects, the multiple sets of CMRs may be indicated (e.g., explicitly) via a CSI report setting associated with the CSI report. For example, for periodic CSI reports, a single option of the multiple sets of CMRs may be RRC configured by the CSI report setting associated with the CSI report. In other examples, a CSI report setting associated with the CSI report may indicate multiple options of multiple sets of CMRs (e.g., for semi-persistent and/or aperiodic CSI reports). In such examples, the multiple sets of CMRs may be indicated (e.g., an option from the multiple options may be indicated) via a MAC-CE communication activating the CSI report (e.g., for semi-persistent CSI reports) or a downlink control information communication triggering the CSI report (e.g., for aperiodic CSI reports). For example, there may be multiple options of subset selection patterns of multiple sets of CMRs (indicated to the UE 120 as described above) that are RRC configured by the CSI report setting associated with the CSI report. A MAC-CE activating the CSI report may indicate one of the options. As another example, a CSI triggering state configuration associated with the CSI report may be associated with one of the options. The UE 120 may identify an option based at least in part on the CSI triggering state being indicated by DCI.

In some aspects, the UE 120 may use RSRP fingerprints for beam blockage prediction. RSRP fingerprints may represent a time series of RSRP (e.g., L1-RSRP) measurements associated with spatially swept beams (e.g., network node 110 transmit beams). The network node 110 may use such RSRP fingerprints to train machine learning models for predicting beam blockage, including predicting a beam blockage event and a corresponding instance, severity, and direction, among other information. By training the machine learning models using RSRP fingerprints, the network node 110 may associate (e.g., label) actual beam failure instances with corresponding beam IDs (e.g., indices, indicators), which may improve the accuracy of beam blockage predictions. For example, if the RSRP fingerprint indicates a future period of time in which a set of beams may be entirely blocked, the RSRP fingerprint may indicate jittering before the blockage instance, which may trigger the prediction of the upcoming beam blockage.

The network node 110 may transmit a set of beams (e.g., SSB resources, CSI-RS resources) in different directions, which the UE 120 may receive via one or more receive beams. The UE 120 may periodically measure and report measured RSRPs associated with the set of beams transmitted in different directions (e.g., spatially swept SSB or CSI-RS resources). The network node 110 may use an AI/ML model (e.g., a recurrent neural network (RNN) model) to predict beam blockages, where the machine learning model may be trained using the reported RSRPs. In this way, the network node 110 may use the machine learning model to predict beam blockage in future time periods. In some aspects, the UE 120 may report the strongest measured RSRPs to the network node 110. For example, the UE 120 may measure and report the measurements of up to the four strongest SSB beams or CSI-RS beams transmitted by the network node 110, which may fail to efficiently and accurately reflect the characteristics of an RSRP fingerprint (e.g., as only the strongest measurements are included). However, reporting every measuring and reporting RSRPs for every beam may result in increased overhead consumption at the UE 120 (e.g., increased power and resource usage).

In some aspects, the UE 120 may use measurement (e.g., RSRP) reporting schemes where the UE 120 may report measured channel characteristics (e.g., RSRPs, SINRs) of beams (e.g., reference signal resources) that may have or lack the strongest measurements. That is, which measurement information the UE 120 reports may be based on a configuration indicated from the network node 110, a dynamic indication from the network node 110, or a determination by the UE 120. By reporting measurement information of various beams (e.g., instead of just for the beams with strongest or highest measurements), the UE 120 may more efficiently and accurately report an RSRP fingerprint of an environment of the wireless network 100, which may enable the network node 110 to more accurately predict beam blockages. In addition, signaling and power consumption at the UE 120 may be further reduced as the UE 120 and the network node 110 may use variable payload sizes or variable quantization granularities when measuring and reporting the measurements.

In some cases, the network node 110 may indicate specific beams (e.g., reference signal resources) to a UE 120 to measure and include measurement information for in the report, the indication identifying a set of reference signal resource IDs corresponding to the specific beams. Alternatively, the network node 110 may indicate a particular (e.g., designated) set of reference signal resource IDs of multiple sets to the UE 120, where the UE 120 may measure and include measurement information in the report for beams corresponding to the reference signal resource IDs in the indicated set. In some aspects, the network node 110 may indicate multiple sets of reference signal resource IDs corresponding to beams, where the UE 120 may select one set (e.g., the second set) from the indicated multiple sets of beams to measure and include measurement information for in the report based on one or more criteria. As such, the UE 120 may transmit a report to the network node 110 indicating the measurement information of the beams corresponding to the set of reference signal resource IDs in the selected set, which may reduce signaling overhead at the UE 120 and improve the efficiency of communications between the UE 120 and the network node 110.

In some aspects, the beams and/or sets of reference signal resource IDs corresponding to beams (e.g., to be associated with a CSI report) may be randomly selected in a similar manner as described elsewhere herein. For example, configured and/or indicated patterns for the purpose of indicating to the UE 120 which specific beam measurements should be reported to the network node 110 may be random patterns (e.g., based at least in part on one or more random seed values) in a similar manner as described in more detail elsewhere herein. For example, the reporting pattern may be random and/or may be different across different time domain reporting occasions.

As shown by reference number 720, the UE 120 may determine a subset of CMRs for a given time domain measurement occasion. For example, the UE 120 may determine and/or select a subset of CMRs (or a set of CMRs) from the one or more sets of CMRs. As described above, the subset of CMRs may be randomly selected and may be associated with, or mapped to, the given time domain measurement occasion based at least in part on signaling received from the network node 110. The subset of CMRs may be CMRs that are to be measured by the UE 120 during the given time domain measurement occasion. For example, the UE 120 may measure the subset of CMRs and may use the measurements to predict measurement values and/or other parameters for other CMRs (e.g., that are not actually measured by the UE 120). In other words, for the given measurement occasion, the subset of CMRs may be associated with set B beams for predictive beam management. As described above, for other time domain measurement occasions, the subset of CMRs measured by the UE 120 may be different (e.g., may be a different randomly selected subset of CMRs).

As shown by reference number 725, the network node 110 may transmit, and the UE 120 may receive, one or more signals. For example, the network node 110 may transmit the signal(s) (e.g., SSBs, CSI-RSs, and/or other reference signals) using resources associated with configured CMRs. In some aspects, the network node 110 may transmit signals using all CMRs from the one or more sets of CMRs (e.g., the network node 110 may transmit signals via all beams included in the set A beams). In other aspects, the network node 110 may transmit signals using the subset of CMRs that are associated with a current time domain measurement occasion. In other words, the network node 110 may only transmit signals via the set B beams for the current time domain measurement occasion (e.g., which may be associated with a randomly selected subset of CMRs, as described elsewhere herein).

As shown by reference number 730, the UE 120 may perform measurements of the signals that are associated with the subset of CMRs. For example, the UE 120 may perform L1 RSRP measurements, L1 SINR measurements, CQI measurements, RI measurements, PMI measurements, and/or LI measurements, among other examples, of the signals that are associated with the subset of CMRs (e.g., that are associated with the time domain measurement occasion in which the measurements occur). In other words, the UE 120 may measure, at a measurement occasion of the respective measurement occasions, a subset of CMRs, from the subsets of CMRs, that is indicated as being associated with the measurement occasion by the association (e.g., that is signaled to the UE 120 as described above).

As shown by reference number 735, the UE 120 may determine one or more predicted measurements of the other CMRs (e.g., that are not measured) using the measurements (e.g., performed as described above in connection with reference number 730). For example, the UE 120 may input the measurements performed by the UE 120 and indication(s) of a random pattern or selection pattern used to select or determine the subset of CMRs (or beam/spatial/QCL information determined by the UE 120 based at least in part on the pattern) to an AI/ML model. The AI/ML model may output predicted measurement values or parameters associated with the other CMRs, as described in more detail elsewhere herein. In some aspects, the prediction may be based at least in part on measurements performed at a single time domain measurement occasion. In other aspects, the prediction may be based at least in part on measurements performed at multiple time domain measurement occasions (e.g., the UE 120 may input measurements performed at multiple time domain measurement occasions into the AI/ML model to obtain the prediction(s)).

As shown by reference number 740, the UE 120 may transmit, and the network node 110 may receive, a CSI report that includes predicted measurement values associated with one or more CMRs. In some aspects, the CSI report may indicate one or more measurements performed by the UE 120 (e.g., as described above in connection with reference number 730). For example, a first one or more measurement values, from the measurement values, associated with the first set of resources may be measured by the UE 120 (e.g., as described above in connection with reference number 730). A second one or more measurement values, from the measurement values, associated with the second set of resources may be predicted by the UE 120 based at least in part on the first one or more measurement values (e.g., as described above in connection with reference number 735).

As a result, the UE 120 may be enabled to use a random pattern of CMRs to measure (e.g., a random pattern of set B beams) to facilitate beam measurement predictions. For example, the signaling described herein may ensure that the UE 120 and one or more network nodes (e.g., a network node that transmits signals to be measured by the UE 120 and/or a network node that receives the CSI report) are synchronized as to which beams (e.g., which CMRs) are to be measured by the UE 120 at a given time domain measurement occasion. Enabling the use of a random pattern of CMRs to be measured by the UE 120 (e.g., a random pattern of set B beams) to facilitate beam measurement predictions may improve a performance and/or accuracy of the beam measurement predictions (e.g., because the predictions may not be based on actual beam measurements of a beam that is associated with a blockage, interference, or another condition affecting performances of signals communicated via the beam).

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with signaling for random measurement beam patterns for beam measurement predictions.

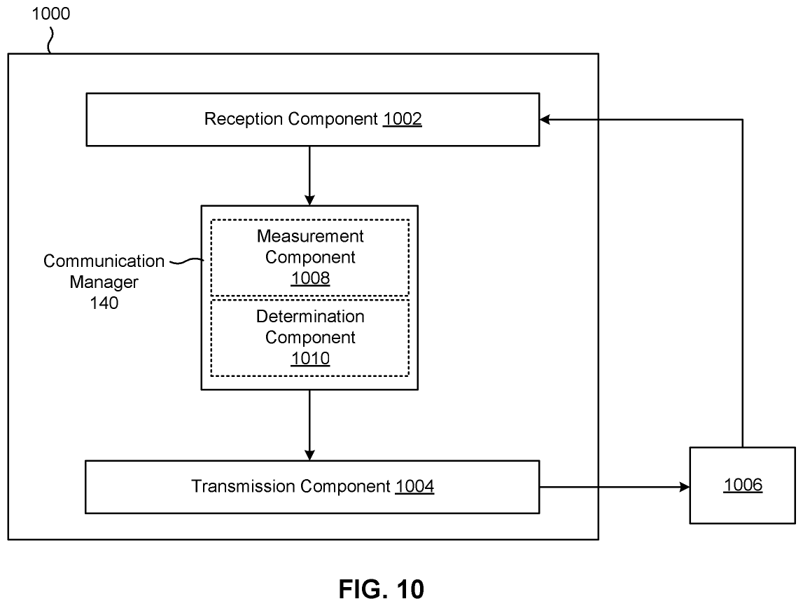

As shown in FIG. 8, in some aspects, process 800 may include receiving, from a network node, configuration information indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions (block 810). For example, the UE (e.g., using communication manager 140 and/or reception component 1002, depicted in FIG. 10) may receive, from a network node, configuration information indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions, as described above.

As further shown in FIG. 8, in some aspects, process 800 may include measuring, at a time domain measurement occasion of the respective time domain measurement occasions, a subset of CMRs, from the subsets of CMRs, that is indicated as being associated with the time domain measurement occasion by the association (block 820). For example, the UE (e.g., using communication manager 140 and/or measurement component 1008, depicted in FIG. 10) may measure, at a time domain measurement occasion of the respective time domain measurement occasions, a subset of CMRs, from the subsets of CMRs, that is indicated as being associated with the time domain measurement occasion by the association, as described above.

As further shown in FIG. 8, in some aspects, process 800 may include transmitting, to the network node, the CSI report, wherein the CSI report includes predicted measurement values associated with the one or more CMRs, and wherein the predicted measurement values are based at least in part on the measurements of the subset of CMRs (block 830). For example, the UE (e.g., using communication manager 140 and/or transmission component 1004, depicted in FIG. 10) may transmit, to the network node, the CSI report, wherein the CSI report includes predicted measurement values associated with the one or more CMRs, and wherein the predicted measurement values are based at least in part on the measurements of the subset of CMRs, as described above.

Process 800 may include additional aspects, such as any single aspect or any combination of aspects described below and/or in connection with one or more other processes described elsewhere herein.

In a first aspect, the subsets of CMRs, from the one or more sets of CMRs, are randomly selected.

In a second aspect, alone or in combination with the first aspect, the configuration information is associated with at least one of RRC signaling, MAC control element signaling, or DCI signaling.

In a third aspect, alone or in combination with one or more of the first and second aspects, the subsets of CMRs, from the one or more sets of CMRs, are based at least in part on a CMR pattern, wherein the CMR pattern defines CMRs that are included in the subsets of CMRs.

In a fourth aspect, alone or in combination with one or more of the first through third aspects, the predicted measurement values associated with the one or more CMRs are based at least in part on an output of a prediction model, and the measurements of the subset of CMRs and the CMR pattern are provided as inputs to the prediction model.

In a fifth aspect, alone or in combination with one or more of the first through fourth aspects, the CMR pattern is a random pattern defined by one or more random seed values.

In a sixth aspect, alone or in combination with one or more of the first through fifth aspects, process 800 includes receiving an indication of the one or more random seed values, and determining the subset of CMRs based on the one or more sets of CMRs and the one or more random seed values.

In a seventh aspect, alone or in combination with one or more of the first through sixth aspects, the association between the subsets of CMRs, from the one or more sets of CMRs, and the respective time domain measurement occasions is based at least in part on the CMR pattern and is defined by a wireless communication standard.

In an eighth aspect, alone or in combination with one or more of the first through seventh aspects, the association between the subsets of CMRs, from the one or more sets of CMRs, and the respective time domain measurement occasions is based at least in part on the CMR pattern and is included in the configuration information.

In a ninth aspect, alone or in combination with one or more of the first through eighth aspects, the CMR pattern is based at least in part on at least one of a slot, subframe, or frame identifier associated with the CSI report.

In a tenth aspect, alone or in combination with one or more of the first through ninth aspects, process 800 includes receiving an indication of the CMR pattern.

In an eleventh aspect, alone or in combination with one or more of the first through tenth aspects, the indication of the CMR pattern indicates CMRs that are included in each of the subsets of CMRs.

In a twelfth aspect, alone or in combination with one or more of the first through eleventh aspects, the indication of the CMR pattern indicates that the subsets of CMRs are a single subset of CMRs.

In a thirteenth aspect, alone or in combination with one or more of the first through twelfth aspects, the CMR pattern is indicated via a CSI report setting associated with the CSI report.

In a fourteenth aspect, alone or in combination with one or more of the first through thirteenth aspects, a CSI report setting associated with the CSI report indicates multiple CMR patterns, and the CMR pattern is indicated via a MAC control element communication activating the CSI report or a downlink control information communication triggering the CSI report.

In a fifteenth aspect, alone or in combination with one or more of the first through fourteenth aspects, process 800 includes receiving QCL information associated with the one or more sets of CMRs, wherein the subset of CMRs is defined via the QCL information and the association.

In a sixteenth aspect, alone or in combination with one or more of the first through fifteenth aspects, the QCL information is included in the configuration information or is indicated via MAC control element signaling or downlink control information signaling.

In a seventeenth aspect, alone or in combination with one or more of the first through sixteenth aspects, the predicted measurement values associated with the one or more CMRs are based at least in part on an output of a prediction model, and the measurements of the subset of CMRs and the QCL information are provided as inputs to the prediction model.

In an eighteenth aspect, alone or in combination with one or more of the first through seventeenth aspects, process 800 includes determining the subsets of CMRs based at least in part on the QCL information and one or more random seed values, wherein each subset of CMRs, from the one or more sets of CMRs, includes one or more QCL source resource identifiers indicated by the QCL information.

In a nineteenth aspect, alone or in combination with one or more of the first through eighteenth aspects, the subsets of CMRs are based at least in part on randomly selected QCL source resource identifiers indicated by the QCL information, and the association is defined by a wireless communication standard or included in the configuration information.

In a twentieth aspect, alone or in combination with one or more of the first through nineteenth aspects, the randomly selected QCL source resource identifiers are based at least in part on at least one of a slot, subframe, or frame identifier associated with the CSI report.

In a twenty-first aspect, alone or in combination with one or more of the first through twentieth aspects, the QCL information is included in a CSI report setting associated with the CSI report.

In a twenty-second aspect, alone or in combination with one or more of the first through twenty-first aspects, process 800 includes receiving an indication of QCL source resource identifiers, indicated by the QCL information, for each subset of the subsets of CMRs.

In a twenty-third aspect, alone or in combination with one or more of the first through twenty-second aspects, the indication of the QCL source resource identifiers, indicated by the QCL information, for each subset of the subsets of CMRs is included in a CSI report setting associated with the CSI report.

In a twenty-fourth aspect, alone or in combination with one or more of the first through twenty-third aspects, the CSI report setting indicates multiple options of QCL source resource identifiers, indicated by the QCL information, for each subset, and the QCL source resource identifiers are indicated, from the multiple options, via a MAC control element communication activating the CSI report or a downlink control information communication triggering the CSI report.

In a twenty-fifth aspect, alone or in combination with one or more of the first through twenty-fourth aspects, the one or more sets of CMRs includes multiple sets of CMRs, wherein the multiple sets of CMRs are each associated with a same time domain periodicity, and wherein the multiple sets of CMRs are associated with different time domain offset values.

In a twenty-sixth aspect, alone or in combination with one or more of the first through twenty-fifth aspects, the predicted measurement values associated with the one or more CMRs are based at least in part on an output of a prediction model, and the measurements of the subset of CMRs and the multiple sets of CMRs are provided as inputs to the prediction model.

In a twenty-seventh aspect, alone or in combination with one or more of the first through twenty-sixth aspects, the multiple sets of CMRs include randomly selected CMR sets, and the randomly selected CMR sets are based at least in part on one or more random seed values and candidate CMR sets.

In a twenty-eighth aspect, alone or in combination with one or more of the first through twenty-seventh aspects, the candidate CMR sets are indicated via a CSI report setting associated with the CSI report.

In a twenty-ninth aspect, alone or in combination with one or more of the first through twenty-eighth aspects, process 800 includes receiving an indication of the multiple sets of CMRs.

In a thirtieth aspect, alone or in combination with one or more of the first through twenty-ninth aspects, the one or more CMRs are associated with a transmission by the network node and are not measured by the UE.

In a thirty-first aspect, alone or in combination with one or more of the first through thirtieth aspects, the one or more CMRs are not associated with a transmission by the network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with signaling for random measurement beam patterns for beam measurement predictions.

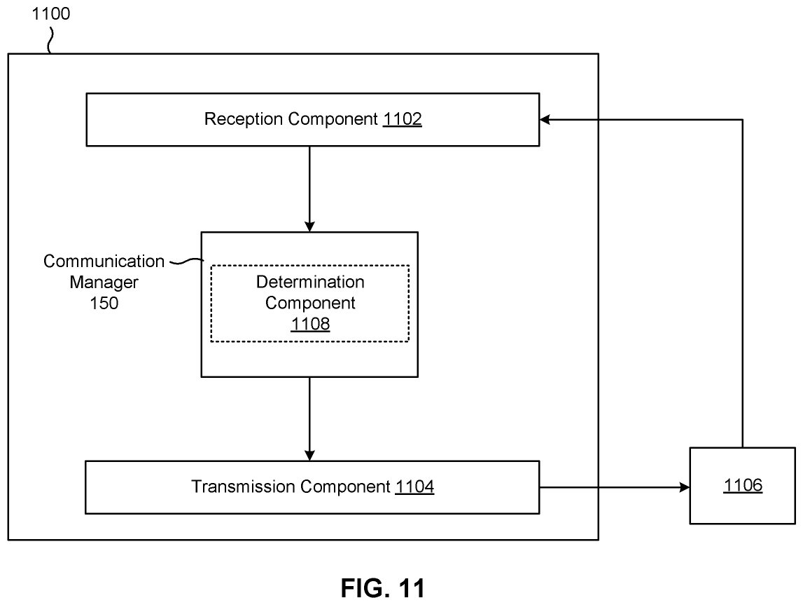

As shown in FIG. 9, in some aspects, process 900 may include transmitting configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions (block 910). For example, the network node (e.g., using communication manager 150 and/or transmission component 1104, depicted in FIG. 11) may transmit configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions, as described above.

As further shown in FIG. 9, in some aspects, process 900 may include receiving the CSI report, wherein the CSI report includes predicted measurement values associated with the one or more CMRs, and wherein the predicted measurement values are based at least in part on measurements of a subset of CMRs from the subsets of CMRs (block 920). For example, the network node (e.g., using communication manager 150 and/or reception component 1102, depicted in FIG. 11) may receive the CSI report, wherein the CSI report includes predicted measurement values associated with the one or more CMRs, and wherein the predicted measurement values are based at least in part on measurements of a subset of CMRs from the subsets of CMRs, as described above.

Process 900 may include additional aspects, such as any single aspect or any combination of aspects described below and/or in connection with one or more other processes described elsewhere herein.

In a first aspect, the subsets of CMRs, from the one or more sets of CMRs, are randomly selected.

In a second aspect, alone or in combination with the first aspect, the configuration information is associated with at least one of RRC signaling, MAC control element signaling, or DCI signaling.

In a third aspect, alone or in combination with one or more of the first and second aspects, the subsets of CMRs, from the one or more sets of CMRs, are based at least in part on a CMR pattern, wherein the CMR pattern defines CMRs that are included in the subsets of CMRs.

In a fourth aspect, alone or in combination with one or more of the first through third aspects, the CMR pattern is a random pattern defined by one or more random seed values.

In a fifth aspect, alone or in combination with one or more of the first through fourth aspects, process 900 includes transmitting an indication of the one or more random seed values.

In a sixth aspect, alone or in combination with one or more of the first through fifth aspects, the association between the subsets of CMRs, from the one or more sets of CMRs, and the respective time domain measurement occasions is based at least in part on the CMR pattern and is defined by a wireless communication standard.

In a seventh aspect, alone or in combination with one or more of the first through sixth aspects, the association between the subsets of CMRs, from the one or more sets of CMRs, and the respective time domain measurement occasions is based at least in part on the CMR pattern and is included in the configuration information.

In an eighth aspect, alone or in combination with one or more of the first through seventh aspects, the CMR pattern is based at least in part on at least one of a slot, subframe, or frame identifier associated with the CSI report.

In a ninth aspect, alone or in combination with one or more of the first through eighth aspects, process 900 includes transmitting an indication of the CMR pattern.

In a tenth aspect, alone or in combination with one or more of the first through ninth aspects, the indication of the CMR pattern indicates CMRs that are included in each of the subsets of CMRs.

In an eleventh aspect, alone or in combination with one or more of the first through tenth aspects, the indication of the CMR pattern indicates that the subsets of CMRs are a single subset of CMRs.

In a twelfth aspect, alone or in combination with one or more of the first through eleventh aspects, the CMR pattern is indicated via a CSI report setting associated with the CSI report.

In a thirteenth aspect, alone or in combination with one or more of the first through twelfth aspects, a CSI report setting associated with the CSI report indicates multiple CMR patterns, and the CMR pattern is indicated via a MAC control element communication activating the CSI report or a downlink control information communication triggering the CSI report.

In a fourteenth aspect, alone or in combination with one or more of the first through thirteenth aspects, process 900 includes transmitting QCL information associated with the one or more sets of CMRs, wherein the subset of CMRs is defined via the QCL information and the association.

In a fifteenth aspect, alone or in combination with one or more of the first through fourteenth aspects, the QCL information is included in the configuration information or is indicated via MAC control element signaling or downlink control information signaling.

In a sixteenth aspect, alone or in combination with one or more of the first through fifteenth aspects, the predicted measurement values associated with the one or more CMRs are based at least in part on an output of a prediction model, and the measurements of the subset of CMRs and the QCL information are provided as inputs to the prediction model.

In a seventeenth aspect, alone or in combination with one or more of the first through sixteenth aspects, the subsets of CMRs are based at least in part on randomly selected QCL source resource identifiers indicated by the QCL information, and the association is defined by a wireless communication standard or included in the configuration information.

In an eighteenth aspect, alone or in combination with one or more of the first through seventeenth aspects, the randomly selected QCL source resource identifiers are based at least in part on at least one of a slot, subframe, or frame identifier associated with the CSI report.

In a nineteenth aspect, alone or in combination with one or more of the first through eighteenth aspects, the QCL information is included in a CSI report setting associated with the CSI report.

In a twentieth aspect, alone or in combination with one or more of the first through nineteenth aspects, process 900 includes transmitting an indication of QCL source resource identifiers, indicated by the QCL information, for each subset of the subsets of CMRs.

In a twenty-first aspect, alone or in combination with one or more of the first through twentieth aspects, the indication of the QCL source resource identifiers, indicated by the QCL information, for each subset of the subsets of CMRs is included in a CSI report setting associated with the CSI report.

In a twenty-second aspect, alone or in combination with one or more of the first through twenty-first aspects, the CSI report setting indicates multiple options of QCL source resource identifiers, indicated by the QCL information, for each subset, and the QCL source resource identifiers are indicated, from the multiple options, via a MAC control element communication activating the CSI report or a downlink control information communication triggering the CSI report.

In a twenty-third aspect, alone or in combination with one or more of the first through twenty-second aspects, the one or more sets of CMRs includes multiple sets of CMRs, wherein the multiple sets of CMRs are each associated with a same time domain periodicity, and wherein the multiple sets of CMRs are associated with different time domain offset values.

In a twenty-fourth aspect, alone or in combination with one or more of the first through twenty-third aspects, the predicted measurement values associated with the one or more CMRs are based at least in part on an output of a prediction model, and the measurements of the subset of CMRs and the multiple sets of CMRs are provided as inputs to the prediction model.

In a twenty-fifth aspect, alone or in combination with one or more of the first through twenty-fourth aspects, the multiple sets of CMRs include randomly selected CMR sets, and the randomly selected CMR sets are based at least in part on one or more random seed values and candidate CMR sets.

In a twenty-sixth aspect, alone or in combination with one or more of the first through twenty-fifth aspects, the candidate CMR sets are indicated via a CSI report setting associated with the CSI report.

In a twenty-seventh aspect, alone or in combination with one or more of the first through twenty-sixth aspects, process 900 includes transmitting an indication of the multiple sets of CMRs.

In a twenty-eighth aspect, alone or in combination with one or more of the first through twenty-seventh aspects, the one or more CMRs are associated with a transmission by the network node and are not measured by the UE.

In a twenty-ninth aspect, alone or in combination with one or more of the first through twenty-eighth aspects, the one or more CMRs are not associated with a transmission by the network node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a measurement component 1008, and/or a determination component 1010, among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2.

Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network node, configuration information indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The measurement component 1008 may measure, at a time domain measurement occasion of the respective time domain measurement occasions, a subset of CMRs, from the subsets of CMRs, that is indicated as being associated with the time domain measurement occasion by the association. The transmission component 1004 may transmit, to the network node, the CSI report, wherein the CSI report includes predicted measurement values associated with the one or more CMRs, and wherein the predicted measurement values are based at least in part on the measurements of the subset of CMRs.

The reception component 1002 may receive an indication of the one or more random seed values.

The determination component 1010 may determine the subset of CMRs based on the one or more sets of CMRs and the one or more random seed values.

The reception component 1002 may receive an indication of the CMR pattern.

The reception component 1002 may receive QCL information associated with the one or more sets of CMRs, wherein the subset of CMRs is defined via the QCL information and the association.

The determination component 1010 may determine the subsets of CMRs based at least in part on the QCL information and one or more random seed values, wherein each subset of CMRs, from the one or more sets of CMRs, includes one or more QCL source resource identifiers indicated by the QCL information.

The reception component 1002 may receive an indication of QCL source resource identifiers, indicated by the QCL information, for each subset of the subsets of CMRs.

The reception component 1002 may receive an indication of the multiple sets of CMRs.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit configuration information, associated with a UE, indicating one or more sets of CMRs associated with a CSI report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions. The reception component 1102 may receive the CSI report, wherein the CSI report includes predicted measurement values associated with the one or more CMRs, and wherein the predicted measurement values are based at least in part on measurements of a subset of CMRs from the subsets of CMRs.

The determination component 1108 may determine the subsets of CMRs and/or the subset of CMRs. The determination component 1108 may determine the association between subsets of CMRs, from the one or more sets of CMRs, and respective time domain measurement occasions

The transmission component 1104 may transmit an indication of the one or more random seed values.

The transmission component 1104 may transmit an indication of the CMR pattern. The determination component 1108 may determine the CMR pattern.

The transmission component 1104 may transmit quasi co-location (QCL) information associated with the one or more sets of CMRs, wherein the subset of CMRs is defined via the QCL information and the association.

The transmission component 1104 may transmit an indication of QCL source resource identifiers, indicated by the QCL information, for each subset of the subsets of CMRs.

The transmission component 1104 may transmit an indication of the multiple sets of CMRs.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a network node, configuration information indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; measuring, at a time domain measurement occasion of the respective time domain measurement occasions, a subset of CMRs, from the subsets of CMRs, that is indicated as being associated with the time domain measurement occasion by the association; and transmitting, to the network node, the CSI report, wherein the CSI report includes predicted measurement values associated with the one or more CMRs, and wherein the predicted measurement values are based at least in part on the measurements of the subset of CMRs.

Aspect 2: The method of Aspect 1, wherein the subsets of CMRs, from the one or more sets of CMRs, are randomly selected.

Aspect 3: The method of any of Aspects 1-2, where the configuration information is associated with at least one of: radio resource control (RRC) signaling, medium access control (MAC) control element signaling, or downlink control information (DCI) signaling.

Aspect 4: The method of any of Aspects 1-3, wherein the subsets of CMRs, from the one or more sets of CMRs, are based at least in part on a CMR pattern, wherein the CMR pattern defines CMRs that are included in the subsets of CMRs.

Aspect 5: The method of Aspect 4, wherein the predicted measurement values associated with the one or more CMRs are based at least in part on an output of a prediction model, and wherein the measurements of the subset of CMRs and the CMR pattern are provided as inputs to the prediction model.

Aspect 6: The method of any of Aspects 4-5, wherein the CMR pattern is a random pattern defined by one or more random seed values.

Aspect 7: The method of Aspect 6, further comprising: receiving an indication of the one or more random seed values; and determining the subset of CMRs based on the one or more sets of CMRs and the one or more random seed values.

Aspect 8: The method of any of Aspects 4-7, wherein the association between the subsets of CMRs, from the one or more sets of CMRs, and the respective time domain measurement occasions is based at least in part on the CMR pattern and is defined by a wireless communication standard.

Aspect 9: The method of any of Aspects 4-8, wherein the association between the subsets of CMRs, from the one or more sets of CMRs, and the respective time domain measurement occasions is based at least in part on the CMR pattern and is included in the configuration information.

Aspect 10: The method of any of Aspects 4-9, wherein the CMR pattern is based at least in part on at least one of a slot, subframe, or frame identifier associated with the CSI report.

Aspect 11: The method of any of Aspects 4-10, further comprising: receiving an indication of the CMR pattern.

Aspect 12: The method of Aspect 11, wherein the indication of the CMR pattern indicates CMRs that are included in each of the subsets of CMRs.

Aspect 13: The method of any of Aspects 11-12, wherein the indication of the CMR pattern indicates that the subsets of CMRs are a single subset of CMRs.

Aspect 14: The method of any of Aspects 4-13, wherein the CMR pattern is indicated via a CSI report setting associated with the CSI report.

Aspect 15: The method of any of Aspects 4-14, wherein a CSI report setting associated with the CSI report indicates multiple CMR patterns, and wherein the CMR pattern is indicated via a medium access control (MAC) control element communication activating the CSI report or a downlink control information communication triggering the CSI report.

Aspect 16: The method of any of Aspects 1-15, further comprising: receiving quasi co-location (QCL) information associated with the one or more sets of CMRs, wherein the subset of CMRs is defined via the QCL information and the association.

Aspect 17: The method of Aspect 16, wherein the QCL information is included in the configuration information or is indicated via medium access control (MAC) control element signaling or downlink control information signaling.

Aspect 18: The method of any of Aspects 16-17, wherein the predicted measurement values associated with the one or more CMRs are based at least in part on an output of a prediction model, and wherein the measurements of the subset of CMRs and the QCL information are provided as inputs to the prediction model.

Aspect 19: The method of any of Aspects 16-18, further comprising: determining the subsets of CMRs based at least in part on the QCL information and one or more random seed values, wherein each subset of CMRs, from the one or more sets of CMRs, includes one or more QCL source resource identifiers indicated by the QCL information.

Aspect 20: The method of any of Aspects 16-19, wherein the subsets of CMRs are based at least in part on randomly selected QCL source resource identifiers indicated by the QCL information, and wherein the association is defined by a wireless communication standard or included in the configuration information.

Aspect 21: The method of Aspect 20, wherein the randomly selected QCL source resource identifiers are based at least in part on at least one of a slot, subframe, or frame identifier associated with the CSI report.

Aspect 22: The method of any of Aspects 16-21, wherein the QCL information is included in a CSI report setting associated with the CSI report.

Aspect 23: The method of any of Aspects 16-22, further comprising: receiving an indication of QCL source resource identifiers, indicated by the QCL information, for each subset of the subsets of CMRs.

Aspect 24: The method of Aspect 23, wherein the indication of the QCL source resource identifiers, indicated by the QCL information, for each subset of the subsets of CMRs is included in a CSI report setting associated with the CSI report.

Aspect 25: The method of Aspect 24, wherein the CSI report setting indicates multiple options of QCL source resource identifiers, indicated by the QCL information, for each subset, and wherein the QCL source resource identifiers are indicated, from the multiple options, via a medium access control (MAC) control element communication activating the CSI report or a downlink control information communication triggering the CSI report.

Aspect 26: The method of any of Aspects 1-25, wherein the one or more sets of CMRs includes multiple sets of CMRs, wherein the multiple sets of CMRs are each associated with a same time domain periodicity, and wherein the multiple sets of CMRs are associated with different time domain offset values.

Aspect 27: The method of Aspect 26, wherein the predicted measurement values associated with the one or more CMRs are based at least in part on an output of a prediction model, and wherein the measurements of the subset of CMRs and the multiple sets of CMRs are provided as inputs to the prediction model.

Aspect 28: The method of any of Aspects 26-27, wherein the multiple sets of CMRs include randomly selected CMR sets, and wherein the randomly selected CMR sets are based at least in part on one or more random seed values and candidate CMR sets.

Aspect 29: The method of Aspect 28, wherein the candidate CMR sets are indicated via a CSI report setting associated with the CSI report.

Aspect 30: The method of any of Aspects 26-29, further comprising: receiving an indication of the multiple sets of CMRs.

Aspect 31: The method of any of Aspects 1-30, wherein the one or more CMRs are associated with a transmission by the network node and are not measured by the UE.

Aspect 32: The method of any of Aspects 1-30, wherein the one or more CMRs are not associated with a transmission by the network node.

Aspect 33: A method of wireless communication performed by a network node, comprising: transmitting configuration information, associated with a user equipment (UE), indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; and receiving the CSI report, wherein the CSI report includes predicted measurement values associated with the one or more CMRs, and wherein the predicted measurement values are based at least in part on measurements of a subset of CMRs from the subsets of CMRs.

Aspect 34: The method of Aspect 33, wherein the subsets of CMRs, from the one or more sets of CMRs, are randomly selected.

Aspect 35: The method of any of Aspects 33-34, where the configuration information is associated with at least one of: radio resource control (RRC) signaling, medium access control (MAC) control element signaling, or downlink control information (DCI) signaling.

Aspect 36: The method of any of Aspects 33-35, wherein the subsets of CMRs, from the one or more sets of CMRs, are based at least in part on a CMR pattern, wherein the CMR pattern defines CMRs that are included in the subsets of CMRs.

Aspect 37: The method of Aspect 36, wherein the CMR pattern is a random pattern defined by one or more random seed values.

Aspect 38: The method of Aspect 37, further comprising: transmitting an indication of the one or more random seed values.

Aspect 39: The method of any of Aspects 36-38, wherein the association between the subsets of CMRs, from the one or more sets of CMRs, and the respective time domain measurement occasions is based at least in part on the CMR pattern and is defined by a wireless communication standard.

Aspect 40: The method of any of Aspects 36-39, wherein the association between the subsets of CMRs, from the one or more sets of CMRs, and the respective time domain measurement occasions is based at least in part on the CMR pattern and is included in the configuration information.

Aspect 41: The method of any of Aspects 36-40, wherein the CMR pattern is based at least in part on at least one of a slot, subframe, or frame identifier associated with the CSI report.

Aspect 42: The method of any of Aspects 36-41, further comprising: transmitting an indication of the CMR pattern.

Aspect 43: The method of Aspect 42, wherein the indication of the CMR pattern indicates CMRs that are included in each of the subsets of CMRs.

Aspect 44: The method of any of Aspects 42-43, wherein the indication of the CMR pattern indicates that the subsets of CMRs are a single subset of CMRs.

Aspect 45: The method of any of Aspects 36-44, wherein the CMR pattern is indicated via a CSI report setting associated with the CSI report.

Aspect 46: The method of any of Aspects 36-45, wherein a CSI report setting associated with the CSI report indicates multiple CMR patterns, and wherein the CMR pattern is indicated via a medium access control (MAC) control element communication activating the CSI report or a downlink control information communication triggering the CSI report.

Aspect 47: The method of any of Aspects 33-46, further comprising: transmitting quasi co-location (QCL) information associated with the one or more sets of CMRs, wherein the subset of CMRs is defined via the QCL information and the association.

Aspect 48: The method of Aspect 47, wherein the QCL information is included in the configuration information or is indicated via medium access control (MAC) control element signaling or downlink control information signaling.

Aspect 49: The method of any of Aspects 47-48, wherein the predicted measurement values associated with the one or more CMRs are based at least in part on an output of a prediction model, and wherein the measurements of the subset of CMRs and the QCL information are provided as inputs to the prediction model.

Aspect 50: The method of any of Aspects 47-49, wherein the subsets of CMRs are based at least in part on randomly selected QCL source resource identifiers indicated by the QCL information, and wherein the association is defined by a wireless communication standard or included in the configuration information.

Aspect 51: The method of Aspect 50, wherein the randomly selected QCL source resource identifiers are based at least in part on at least one of a slot, subframe, or frame identifier associated with the CSI report.

Aspect 52: The method of any of Aspects 47-51, wherein the QCL information is included in a CSI report setting associated with the CSI report.

Aspect 53: The method of any of Aspects 47-52, further comprising: transmitting an indication of QCL source resource identifiers, indicated by the QCL information, for each subset of the subsets of CMRs.

Aspect 54: The method of Aspect 53, wherein the indication of the QCL source resource identifiers, indicated by the QCL information, for each subset of the subsets of CMRs is included in a CSI report setting associated with the CSI report.

Aspect 55: The method of Aspect 54, wherein the CSI report setting indicates multiple options of QCL source resource identifiers, indicated by the QCL information, for each subset, and wherein the QCL source resource identifiers are indicated, from the multiple options, via a medium access control (MAC) control element communication activating the CSI report or a downlink control information communication triggering the CSI report.

Aspect 56: The method of any of Aspects 33-55, wherein the one or more sets of CMRs includes multiple sets of CMRs, wherein the multiple sets of CMRs are each associated with a same time domain periodicity, and wherein the multiple sets of CMRs are associated with different time domain offset values.

Aspect 57: The method of Aspect 56, wherein the predicted measurement values associated with the one or more CMRs are based at least in part on an output of a prediction model, and wherein the measurements of the subset of CMRs and the multiple sets of CMRs are provided as inputs to the prediction model.

Aspect 58: The method of any of Aspects 56-57, wherein the multiple sets of CMRs include randomly selected CMR sets, and wherein the randomly selected CMR sets are based at least in part on one or more random seed values and candidate CMR sets.

Aspect 59: The method of Aspect 58, wherein the candidate CMR sets are indicated via a CSI report setting associated with the CSI report.

Aspect 60: The method of any of Aspects 56-59, further comprising: transmitting an indication of the multiple sets of CMRs.

Aspect 61: The method of any of Aspects 33-60, wherein the one or more CMRs are associated with a transmission by the network node and are not measured by the UE.

Aspect 62: The method of any of Aspects 33-60, wherein the one or more CMRs are not associated with a transmission by the network node.

Aspect 63: An apparatus for wireless communication at a device, comprising a processor; memory coupled with the processor; and instructions stored in the memory and executable by the processor to cause the apparatus to perform the method of one or more of Aspects 1-32.

Aspect 64: A device for wireless communication, comprising a memory and one or more processors coupled to the memory, the one or more processors configured to perform the method of one or more of Aspects 1-32.

Aspect 65: An apparatus for wireless communication, comprising at least one means for performing the method of one or more of Aspects 1-32.

Aspect 66: A non-transitory computer-readable medium storing code for wireless communication, the code comprising instructions executable by a processor to perform the method of one or more of Aspects 1-32.

Aspect 67: A non-transitory computer-readable medium storing a set of instructions for wireless communication, the set of instructions comprising one or more instructions that, when executed by one or more processors of a device, cause the device to perform the method of one or more of Aspects 1-32.

Aspect 68: An apparatus for wireless communication at a device, comprising a processor; memory coupled with the processor; and instructions stored in the memory and executable by the processor to cause the apparatus to perform the method of one or more of Aspects 33-62.

Aspect 69: A device for wireless communication, comprising a memory and one or more processors coupled to the memory, the one or more processors configured to perform the method of one or more of Aspects 33-62.

Aspect 70: An apparatus for wireless communication, comprising at least one means for performing the method of one or more of Aspects 33-62.

Aspect 71: A non-transitory computer-readable medium storing code for wireless communication, the code comprising instructions executable by a processor to perform the method of one or more of Aspects 33-62.

Aspect 72: A non-transitory computer-readable medium storing a set of instructions for wireless communication, the set of instructions comprising one or more instructions that, when executed by one or more processors of a device, cause the device to perform the method of one or more of Aspects 33-62.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors, based at least in part on information stored in the one or more memories, configured to:
receive, from a network node, configuration information indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions;
measure, at a time domain measurement occasion of the respective time domain measurement occasions, a subset of CMRs, from the subsets of CMRs, that is indicated as being associated with the time domain measurement occasion by the association; and
transmit, to the network node, the CSI report, wherein the CSI report includes predicted measurement values associated with the one or more CMRs, and wherein the predicted measurement values are based at least in part on the measurements of the subset of CMRs.

2. The apparatus of claim 1, wherein the subsets of CMRs, from the one or more sets of CMRs, are randomly selected.

3. The apparatus of claim 1, wherein the subsets of CMRs, from the one or more sets of CMRs, are based at least in part on a CMR pattern, wherein the CMR pattern defines CMRs that are included in the subsets of CMRs.

4. The apparatus of claim 3, wherein the CMR pattern is a random pattern defined by one or more random seed values.

5. The apparatus of claim 4, wherein the one or more processors are further configured to:
receive an indication of the one or more random seed values; and
determine the subset of CMRs based on the one or more sets of CMRs and the one or more random seed values.

6. The apparatus of claim 3, wherein the one or more processors are further configured to:
receive an indication of the CMR pattern.

7. The apparatus of claim 6, wherein the indication of the CMR pattern indicates that the subsets of CMRs are a single subset of CMRs.

8. The apparatus of claim 3, wherein the CMR pattern is indicated via a CSI report setting associated with the CSI report.

9. The apparatus of claim 3, wherein a CSI report setting associated with the CSI report indicates multiple CMR patterns, and wherein the CMR pattern is indicated via a medium access control (MAC) control element communication activating the CSI report or a downlink control information communication triggering the CSI report.

10. The apparatus of claim 1, wherein the one or more sets of CMRs includes multiple sets of CMRs, wherein the multiple sets of CMRs are each associated with a same time domain periodicity, and wherein the multiple sets of CMRs are associated with different time domain offset values.

11. The apparatus of claim 10, wherein the predicted measurement values associated with the one or more CMRs are based at least in part on an output of a prediction model, and wherein the measurements of the subset of CMRs and the multiple sets of CMRs are provided as inputs to the prediction model.

12. The apparatus of claim 10, wherein the multiple sets of CMRs include randomly selected CMR sets, and wherein the randomly selected CMR sets are based at least in part on one or more random seed values and candidate CMR sets.

13. The apparatus of claim 12, wherein the candidate CMR sets are indicated via a CSI report setting associated with the CSI report.

14. The apparatus of claim 10, wherein the one or more processors are further configured to:
receive an indication of the multiple sets of CMRs.

15. An apparatus for wireless communication at a network node, comprising:
one or more memories; and
one or more processors, based at least in part on information stored in the one or more memories, configured to:
transmit configuration information, associated with a user equipment (UE), indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; and
receive the CSI report, wherein the CSI report includes predicted measurement values associated with the one or more CMRs, and wherein the predicted measurement values are based at least in part on measurements of a subset of CMRs from the subsets of CMRs.

16. The apparatus of claim 15, wherein the subsets of CMRs, from the one or more sets of CMRs, are randomly selected.

17. (canceled)

18. A method of wireless communication performed by a user equipment (UE), comprising:
receiving, from a network node, configuration information indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions;
measuring, at a time domain measurement occasion of the respective time domain measurement occasions, a subset of CMRs, from the subsets of CMRs, that is indicated as being associated with the time domain measurement occasion by the association; and
transmitting, to the network node, the CSI report, wherein the CSI report includes predicted measurement values associated with the one or more CMRs, and wherein the predicted measurement values are based at least in part on the measurements of the subset of CMRs.

19. (canceled)

20. The method of claim 18, wherein the subsets of CMRs, from the one or more sets of CMRs, are based at least in part on a CMR pattern, wherein the CMR pattern defines CMRs that are included in the subsets of CMRs.

21. The method of claim 20, wherein the association between the subsets of CMRs, from the one or more sets of CMRs, and the respective time domain measurement occasions is based at least in part on the CMR pattern and is defined by a wireless communication standard or is included in the configuration information.

22. The method of claim 20, wherein the CMR pattern is based at least in part on at least one of a slot, subframe, or frame identifier associated with the CSI report.

23. The method of claim 20, further comprising:
receiving an indication of the CMR pattern.

24. (canceled)

25. The method of claim 20, wherein the CMR pattern is indicated via a CSI report setting associated with the CSI report.

26. The method of claim 20, wherein a CSI report setting associated with the CSI report indicates multiple CMR patterns, and wherein the CMR pattern is indicated via a medium access control (MAC) control element communication activating the CSI report or a downlink control information communication triggering the CSI report.

27. The method of claim 18, further comprising:
receiving quasi co-location (QCL) information associated with the one or more sets of CMRs, wherein the subset of CMRs is defined via the QCL information and the association.

28. (canceled)

29. The method of claim 27, wherein the subsets of CMRs are based at least in part on randomly selected QCL source resource identifiers indicated by the QCL information, and wherein the association is defined by a wireless communication standard or included in the configuration information.

30. The method of claim 27, wherein the QCL information is included in a CSI report setting associated with the CSI report.

31. The method of claim 27, further comprising:
receiving an indication of QCL source resource identifiers, indicated by the QCL information, for each subset of the subsets of CMRs.

32. The method of claim 31, wherein the indication of the QCL source resource identifiers, indicated by the QCL information, for each subset of the subsets of CMRs is included in a CSI report setting associated with the CSI report.

33. The method of claim 32, wherein the CSI report setting indicates multiple options of QCL source resource identifiers, indicated by the QCL information, for each subset, and wherein the QCL source resource identifiers are indicated, from the multiple options, via a medium access control (MAC) control element communication activating the CSI report or a downlink control information communication triggering the CSI report.

34. A method of wireless communication performed by a network node, comprising:
transmitting configuration information, associated with a user equipment (UE), indicating one or more sets of channel measurement resources (CMRs) associated with a channel state information (CSI) report, wherein the configuration information indicates that the UE is to predict measurements for one or more CMRs from the one or more sets of CMRs, and wherein the configuration information indicates an association between subsets of CMRs, from the one or more sets of CMRs, and respective time domain measurement occasions; and
receiving the CSI report, wherein the CSI report includes predicted measurement values associated with the one or more CMRs, and wherein the predicted measurement values are based at least in part on measurements of a subset of CMRs from the subsets of CMRs.

35-39. (canceled)
